(19) United States
(12) Patent Application Publication
(10) Pub. No.: US 2026/0195834 A1
(43) Pub. Date: Jul. 9, 2026

(54) SMART REQUEST FOR PROPOSAL (RFP)

(71) Applicant: JPMorgan Chase Bank, N.A., NEW YORK, NY (US)

(72) Inventors: Niraja Bhamidipati, Jersey City, NJ (US); Chuan Sun, Bayonne, NJ (US); Siddarth Kalyankar, Bangalore (IN); Mike Wilmot, Rye, NJ (US); Puneet Sharma, Bangalore (IN)

(73) Assignee: JPMorgan Chase Bank, N.A., NEW YORK, NY (US)

(21) Appl. No.: 19/096,300

(22) Filed: Mar. 31, 2025

(30) Foreign Application Priority Data
Jan. 9, 2025 (IN) 202511001969

(51) Int. Cl. G06Q 30/0601

(52) U.S. Cl. CPC G06Q 30/0611

(57) ABSTRACT

The disclosure relates to a system for automating a request for proposal (RFP) process. In one embodiment, the system includes a SmartRFP software tool for initiating and managing response process through a workflow, processing an RFP document to generate an RFP response document. The SmartRFP software tool comprises a user interface, a generative artificial intelligence (GenAI) engine, a content management system and a dashboard reporting function. The user interface receives service requests, client profile data, and manages processing of the RFP document. The GenAI engine extracts content from the RFP document, identifies questions in the RFP document, and generates answers based on the identified questions using an authoritative repository. The GenAI generates the answers by decomposing the identified questions into multiple sub-questions, rephrasing each sub-question, and classifying each rephrased sub-question into one or more topics. The content management system manages and builds the content and stores and retrieves the content from the authoritative repository in collaboration with the GenAI engine. The reporting dashboard renders performance and business insights data.

### CROSS-REFERENCE TO RELATED APPLICATIONS

This application claims benefit to Provisional Patent Application No. 202511001969, filed in India on 9 Jan. 2025, the disclosure of which is incorporated herein in its entirety, by reference.

### FIELD OF TECHNOLOGY

The present disclosure relates to artificial intelligence (AI) and machine learning (ML) technologies, specifically in the automation and management of the request for proposal (RFP) response process.

### BACKGROUND

Many organizations rely on the RFP process to solicit bids from potential suppliers or service providers. This process is crucial for ensuring a consistent procurement process, competitive pricing and quality service delivery. However, the traditional RFP response process is fraught with challenges that may hinder its effectiveness and efficiency.

Historically, the process of responding to an RFP has been manual, requiring significant human intervention for most stages. This manual approach, however, often results in several inefficiencies. In one example, the manual sourcing of potential responses to RFP's by vendors may be labor-intensive and may not always yield the best content for responses, affecting the competitiveness of the RFP response.

Additionally, vendors being able to extract relevant information from a multitude of documents is tedious and error-prone, leading to potential inaccuracies in the content of the RFP response. Manually identifying the right questions to include in the RFP may be challenging, risking the omission of critical inquiries. Retrieving precise data from designated sources manually is inefficient and susceptible to errors, potentially missing key details.

Also, crafting responses manually may be resource-intensive, requiring significant time and expertise, with a high risk of subjectivity and errors that may negatively impact the RFP outcome. Manually integrating responses into an original document layout is complex and time-consuming, requiring meticulous attention to detail. Also time-consuming is coordinating inputs from multiple stakeholders manually, which may lead to inconsistencies, communication gaps, and extended timelines.

Keeping the RFP updated with changes in regulations or company policies manually is time-consuming and prone to errors. On the other hand, ensuring the accuracy and coherence of the RFP manually is exhaustive, with a high potential for human error. A lack of control features in manual RFPs may lead to a mismatch between client expectations, vendor standards and the actual output.

These challenges highlight the need for a more efficient, accurate, and collaborative approach to managing the RFP production process. By leveraging AI and ML technologies, organizations may automate and streamline the RFP process, reducing manual labor, minimizing errors, and enhancing overall effectiveness. This innovation aims to transform the RFP process, making it more adaptable, scalable, and aligned with modern business needs.

### SUMMARY

Given the aforementioned deficiencies, there is a need for systems and methods that automate and streamline the RFP response process.

Under certain circumstances, the disclosure relates to a system for automating a RFP process. In one embodiment, the system includes an SmartRFP software tool for processing an RFP document to generate an RFP response document. The SmartRFP software tool comprises a user interface, workflow to automate and manage the entire RFP business processes, a generative AI (GenAI) engine, a content management system, and a dashboard reporting capability. The user interface receives and manages the processing of the RFP document. The GenAI engine extracts content from the RFP document, identifies questions in the RFP document, and generates answers based on the identified questions using an authoritative repository. The GenAI generates the answers by decomposing the identified questions into multiple sub-questions (SQs), rephrasing each SQ, and classifying each rephrased SQ into one or more topics. The content management system manages and builds the content and stores and retrieves the content from the authoritative repository in collaboration with the GenAI engine. The workflow provides a structured, transparent; process to initiate, track, and manage the tasks involved across different roles and users via the UI. The dashboard provides users visibility of their tickets and their status, as well as system performance for management.

The term “Smart” herein refers to the integration of computing technologies with other technologies to create an intelligent system that may adapt to its environment, learn from experience, and make autonomous decisions. smart may also refer to the integration of advanced technologies, such as AI, ML, cloud computing, and the Internet of Things (IoT), so that the system may be capable of performing tasks with minimal human intervention, optimizing processes, generating responses and enhancing decision-making. The system may be configured to learn from data, adapt to changing conditions, and improve its performance over time through automation and intelligent data analysis.

Through the application of the smart technologies described herein, AI may enable the system to simulate human intelligence, such as recognizing patterns, making decisions, and learning from experiences. ML is a subset of AI that may allow the system and its components to automatically improve their performance through exposure to data. Cloud computing may offer on-demand access to computing resources and services to the system via the Internet, enabling scalability and flexibility. The IoT may provide a network of connected devices that may collect, exchange, and act on data to enhance automation and efficiency. Big data analytics may provide the system with the ability to process and analyze vast amounts of data to extract valuable insights that may drive smarter decisions.

Other aspects of the smart technology described herein that may be features of the system include, for example, awareness, analysis, decision-making, and action. Through awareness, the system and its components may sense and understand their surroundings, including their own status and the status of other applications, systems, and devices. The system and its components may perform analysis to collect and analyze data to identify patterns and trends. The system and its components may apply decision-making to make informed decisions based on the data they collect and analyze. The system and its components may also take actions autonomously or in response to user commands.

Another embodiment provides an AI-based automated RFP response tool referred to herein as SmartRFP. SmartRFP aims to replace the current manual RFP response process with an automated solution. This automated tool strives to improve the efficiency of managing RFP documentation, minimizing errors, and reducing time spent on administrative tasks. SmartRFP also improves collaboration. For example, SmartRFP facilitates seamless collaboration between users, allowing multiple stakeholders to work on the same RFP response simultaneously.

Embodiments of the present disclosure provide an AI-powered tool designed to automate and streamline the RFP process. It addresses the inefficiencies of the traditional manual RFP process by leveraging AI and machine learning technologies to enhance accuracy, efficiency, and collaboration. A few key advantages of the disclosure include the ability to automate the end-to-end RFP process, reducing manual labor, and minimizing errors, and risk.

One embodiment of the disclosure utilizes an authoritative repository, such as Golden Source, for retrieving precise source data, ensuring consistency and accuracy in responses. The Golden Source content database is the authoritative source of information for the LLM/SmartRFP application. n. The Golden Source data must be trusted and the most current, up-to-date version of the data, as well as historical versions. To ensure data integrity and to validate the data, the Golden Source database in itself has a content management workflow capability. This ensures: 1—annual or more frequent as appropriate, for each content type, review and refresh processes are managed automatically through the system; 2—users can trigger a process to re-use the most recent generated answer to update the golden source, flag missing content in the database to trigger a new content generation process. This ensure continuous review and refreshing of the golden source content for quality and governance purposes. The data integrity involves maintaining the consistency, accuracy and trustworthiness of data over its entire lifecycle.

In embodiments, a GenAI engine processes RFPs based on inputs defining the client persona for client, allowing for more customized golden source retrieval and response generation, for example a family office prospect versus and endowment prospect will use different language due to the different nature of the client type, by extracting content, identifying questions vs context, and generating answers based on the Golden Source. Although the embodiments of the present disclosure discuss the Golden Source, other authoritative repositories known to those of skill in the art are within the spirit and scope of the present disclosure. Any other authoritative repositories available within a particular organization that include an information storage and retrieval system with an interface for collecting and cataloging data may be used in one or more embodiments. Some embodiments provide a plug and play framework that provides an option of plugging in content of the user's choice to ensure that the content is complete and convincing for the supplier.

In some embodiments, data sources may include one or more authoritative repositories that provide data that supports the ability to generate RFP responses by understanding document context and matching this understanding with the best answers from a content repository. For example, in some embodiments, one or more authoritative sources may include but are not limited to, corporate, line of businesses, environmental, social, and governance data, prospect portfolio preferences and constraints. Other data may include financial data sources (e.g., investment methodologies, an organization's market view, etc.) and other security-level data obtained from, for example, FACTSET®.

The present disclosure facilitates seamless collaboration among multiple stakeholders, allowing simultaneous work on RFPs. The present disclosure is also capable of tailoring responses to meet specific client needs and preferences, enhancing the relevance and quality of the RFP. The present disclosure is further capable of organizing and managing content throughout the RFP process, supporting content reuse and continuous learning. The present disclosure integrates various stages of the RFP process, ensuring a seamless transition from service request initiation, RFP document input, parsing, AI generation, editing by writers, advisors and compliance users, to final response generation.

The present disclosure significantly reduces the time and effort required for RFP creation, review, and approval processes and minimizes human errors by automating document generation and incorporation of rich content, which helps ensure consistent responses. The present disclosure is also capable of handling various sizes of RFP processes, making it suitable for both small and large-scale businesses.

Further, some recent conventional systems are capable of generating automated RFPs. However, such conventional RFP response systems merely perform simple semantic searches. These conventional tools may include a user interface (UI) that enables the user to input a question and receive one or more answers, where the user may pick any answer. The conventional response tools provide only limited personalization, if any. The conventional response tools provide single question-and-answer responses and do not cater to an entire RFP document and a cohesive, overall RFP response in context. These tools provide limited content management, do not identify winning content, and provide no scoring.

To resolve these issues, embodiments of the present disclosure provide a SmartRFP, which is an innovative, AI-powered tool designed to automate and streamline the RFP process. The tool leverages AI to perform end-to-end RFP processes. It automates the steps of extracting content from documents, identifying questions, and retrieving relevant e answers from a designated Golden Source, plus generating new AI integrated responses, drawing on the context of the client persona and body of relevant golden source answers. The tool also automates the generation of RFP responses, maintaining the original document layout for seamless integration. This results in improved efficiency, accuracy, and collaboration, transforming the way RFP responses are built.

The SmartRFP solution harnesses the power of GenAI and AI/ML to automate the entire RFP process. AI components within SmartRFP perform content extraction, question identification, and answer generation based on the Golden Source. The response generation preserves the original document layout and ensures seamless process integration.

One or more embodiments use a self-managing content management system (SMCMS)/content queue. SMCMS is an intelligent system that organizes and manages content throughout the RFP process. SMCMS helps (i) increase the number of answers, (ii) keep the repository refreshed for future RFPs, and (iii) provide a continuous learning system that enables richer RFPs. In some embodiments, additional adapters may be built on top of a commercial content management system. For instance, a conventional content management system (CMS), which is a web application or software that manages digital content, allowing multiple contributors to create, edit, organize, and publish content, may be employed in various embodiments.

In the present disclosure, the SMCMS includes the ability to self-learn or self-tag to identify winning content and content that has high ratings for the purpose of continuously updating the repository which may be reused for future RFPs. This is an important feature that is not present in the conventional CMS. Therefore, the combination of the techniques of a conventional CMS, content queue (customizations) and the additional tagging feature helps in building the feedback loop of the present disclosure.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a block diagram view of an exemplary smart RFP system for generating an RFP response document according to embodiments of the present disclosure.

FIG. 2 illustrates an exemplary high-level flow diagram of a method for generating the RFP response document according to embodiments of the present disclosure.

FIGS. 3A-3C illustrate an exemplary low-level flow diagram of a method of an Auto RFP phase for generating the RFP response document according to embodiments of the present disclosure.

FIG. 4 is an example illustration of a workflow initiation UI for uploading user RFP documents in accordance with the embodiments of the present disclosure.

FIG. 5 illustrates a flow diagram of an exemplary method of performing AI answer generation in accordance with the embodiments of the present disclosure.

FIG. 6A illustrates a screenshot of an exemplary UI for processing a response to an RFP.

FIG. 6B illustrates a screenshot of another UI for accessing AI-generated answers responsive to the RFP process of FIG. 6A.

FIG. 6C illustrates a screenshot of a UI for accessing an AI answer pipeline in relation to FIG. 6B.

FIG. 7A-7F illustrate various screenshots depicting example uses of AI-generated answers in accordance with the embodiments.

FIG. 8 illustrates a screenshot depicting curated answers in accordance with embodiments of the present disclosure.

FIG. 9 illustrates a screenshot depicting an exemplary graphical user interface (GUI) provided for collaboration between multiple users in accordance with the embodiments.

FIG. 10A illustrates an integrated process of a smart workflow component, a smart writer component, and a smart content component.

FIG. 10B illustrates an alternative smart workflow of the integrated process depicted in FIG. 10A.

FIG. 11 illustrates an exemplary near-term SmartRFP tool in accordance with the embodiments.

FIG. 12 illustrates an exemplary strategic solution for a SmartRFP tool with content workflow.

FIG. 13 illustrates an exemplary strategic solution for a SmartRFP tool with content workflow after replacing intelligent content management (ICM) controls.

FIG. 14 illustrates an exemplary computing system upon which a SmartRFP tool may be implemented in accordance with the embodiments.

FIG. 15 illustrates a flow diagram of another exemplary method of performing AI answer generation in accordance with the embodiments of the present disclosure.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

An RFP is a document that may be used in any industry, including government agencies and businesses, to request proposals from potential suppliers for a product or service. RFPs typically include at least a description of the client, project, a statement of requirements or questions for the project, evaluation criteria for the proposals, a timeline for the RFP response process, and a statement of work that outlines the scope of the work. Conventionally, RFP responses are written manually with individuals scrambling to complete the process, which may include producing content, ensuring the content is correct, and conducting a review of a draft product, and in the context of financial services especially, an independent review and approval process by risk to mitigate legal, risk and compliance risks

To resolve these issues of preparing conventional RFP responses, embodiments of the present disclosure present a SmartRFP tool designed to automate and streamline the RFP process using GenAI. The SmartRFP tool (described below), with the assistance of AI, implements a seamless RFP response workflow process. The SmartRFP tool not only produces RFP responses, but also produces winning RFP responses by identifying winning content from previous RFPs, recommending winning strategies, and analyzing metrics of the winning content.

Some of the goals of the present disclosure include automating the RFP process to replace manual handling, streamlining document management to reduce errors and administrative time, and improving collaboration by allowing multiple stakeholders to work simultaneously.

Some of the objectives of the present disclosure focus on increasing efficiency by reducing the time and effort required for RFP creation, enhancing accuracy by minimizing human errors, improving collaboration through a centralized platform for document sharing and feedback, and enabling data-driven decision-making by providing insights for informed decisions.

In the embodiments, a preparation process of an RFP response document implemented by the SmartRFP tool may include a multi-step process. For example, the preparation process may comprise a first step of writing answers to the questions asked in an RFP document input into the SmartRFP tool. A second step may entail using a content pillar to manage and/or build content and reusing that content. This step includes addressing the question & answer (Q&A) and the extraction and understanding of the RFP document. A third step may enable collaboration between users, allowing multiple stakeholders to work on the same RFP response simultaneously. Ultimately, these steps culminate in a workflow resulting in a composed RFP response document as output implemented through a seamless RFP response workflow process.

Various embodiments of the present disclosure describe herein a comprehensive methodology workflow for producing a response to an RFP using GenAI. The process may begin with an RFP creation stage, where an RFP team initiates a request within an RFP pipeline application. This step may involve inputting data points for personalization and tracking metrics. The team may then upload as input a client's RFP and a questionnaire. The output is the parsed RFP document denoting question versus context, and an AI RFP response, which sets the stage for a more streamlined workflow process that enhances tracking and data management for custom content creation.

In the embodiments, GenAI may perform the entire process: from understanding the RFP document to ensuring that the response fulfills everything the user is seeking. An AI input stage may follow, where the AI system extracts questions and background context necessary for personalization. The AI may then automatically generate and return a completed RFP. This stage may leverage AI-powered content analysis and generation, allowing human participants to focus on nuances and advanced personalization, thereby enhancing the overall quality and relevance of the RFP response.

In an RFP review and edit 1 stage, the RFP team may collaborate with advisors and subject matter experts (SMEs) to revise and complete the approval steps within an exemplary SmartRFP platform, although the embodiments are not limited to this platform. This phase may emphasize smart content collaboration, where a rich user interface integrates with a powerful AI engine to expedite approvals and reviews, ensuring that the RFP response meets all necessary criteria and standards.

In an RFP compliance review and edit stage, the RFP team may collaborate with supervisory management (risk control function), where supervisory management subject matter experts (SMEs) to review, edit, and complete the approval steps within an exemplary SmartRFP platform, although the embodiments are not limited to this platform. This phase may emphasize smart content collaboration, where a rich user interface integrates with a powerful AI engine to expedite approvals and reviews, ensuring that the RFP response meets all necessary criteria and standards.

A final stage, which may be a performance stage, may involve an RFP leadership utilizing pipeline dashboards to track the RFP performance across various dimensions such as industry, region, and other metrics. This capability enables the process to become smarter and improve over time, providing insights that may be used to refine future RFP responses. The integration of these components ensures a comprehensive and efficient approach to managing the RFP process.

The reporting dashboard capability tracks SmartRFP production and performance for management and engineering to continuously improve the process, application and outcomes (data insights where we are winning, as an example).

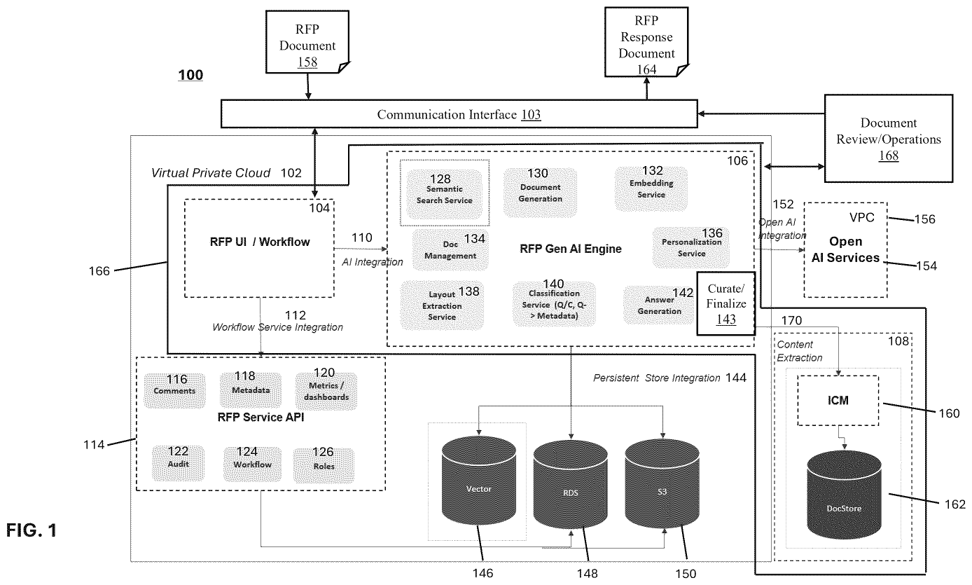

FIG. 1 illustrates a block diagram view of an exemplary system 100 for generating an RFP response document using an automated AI-assisted RFP response tool according to an embodiment of the present disclosure. In an exemplary embodiment, the system 100 may include some main components, such as a virtual private cloud (VPC) 102, a communication interface 103, a SmartRFP tool 166, an RFP service API component 114, a persistent store integration component 144, an open AI services component 154, an ICM component 160, and a downstream review/operations component 168.

By way of example, in at least one embodiment of a general overview, the system 100 using the SmartRFP tool 166 may process an uploaded RFP document 158 in a workflow having multiple stages including a new stage, a drafting stage, a writer review stage, an SME review stage, and a document response stage to generate an RFP response document 164. Initially, the new stage may be used to create an RFP document in the system 100.

During the drafting stage, an AI engine processes the RFP document. The AI engine may process the RFP document by parsing it, identifying questions and context, and providing AI-generated recommendations. The AI engine process may be broken down into four sub-steps including extracting, annotating, generating, and refining.

In the extracting sub-step, the RFP document may be parsed by the AI engine. Questions and the relevant context from the document are identified and extracted.

In the annotating sub-step, AI-generated recommendations may be reviewed and confirmed.

For the generating sub-step, complex questions may be divided into simpler SQs if necessary. Answers may be retrieved from a standard database. Personalized AI-generated answers may be created based on the extracted information and standard data.

The refining sub-step may provide several additional functionalities, for example, users may have the option to choose between relevant golden source answers and AI-generated answers. Users may curate and refine the final answers and add comments. An audit history feature may allow for easy collaboration and tracking of changes.

In the writer review stage, an internal team may review the responses generated by the AI engine. There is a client advisor review stage to edit/refine further.

The SME review stage may enable SMEs to review the simplified final content and approve or disapprove the final answers. Any disapproved answers may be sent back for refinement.

For the document response stage, a final RFP response document 164 may be generated in an original layout to ensure seamless integration with the original RFP document 158.

Throughout the multiple stages of the process carried out by the system 100, intermediary and final smart RFP outputs may be generated. In certain example implementation, the smart RFP outputs generated may include, for example, (i) parsed RFP documents with identified questions and context, (ii) an annotated RFP response document with AI recommendations, (iii) generated answers based on the GenAI engine's analysis and retrieval from a standard database, (iv) a final curated answer with user collaboration and comments, (v) simplified final content for review, and approval/disapproval and (vi) a final RFP response document generated in an original layout.

Specifically, in FIG. 1, the system 100 provides an automated RFP response solution for diverse environments, including VPC and public cloud setups. The example in FIG. 1 illustrates a VPC 102 which may be established for providing a secure and scalable environment for hosting a SmartRFP tool 166. By way of example only, and not limitation, one example of such a private cloud may be the Amazon Web Services (AWS) VPC. The VPC 102 may enable the isolation of resources and ensure secure communication between different components of the system 100. The private cloud may integrate with other cloud services to facilitate seamless data flow and resource management, supporting the overall architecture of the system 100.

As illustrated in FIG. 1 and described in various embodiments of the present disclosure, the SmartRFP tool 166 may include three primary pillars: an RFP UI/Workflow pillar 104, an RFP GenAI engine pillar (i.e., the AI pillar) 106, and a content pillar 108. These three pillars work seamlessly together to provide the underlying capabilities of the SmartRFP tool 166 described herein. In embodiments, the SmartRFP tool 166 may be a SmartRFP software tool having AI technology and configured for processing the RFP document 158 to generate the RFP response document 164.

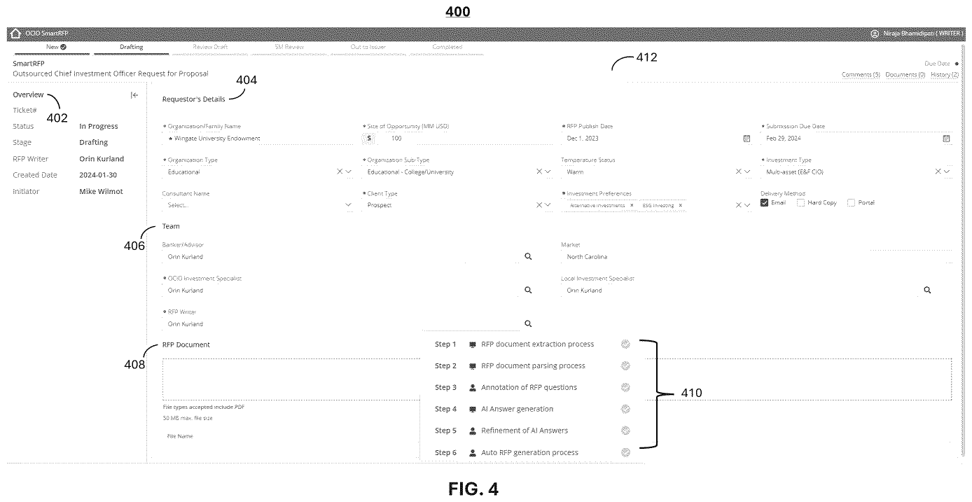

In an embodiment, the SmartRFP tool 166, which includes the UI/Workflow pillar 104, the RFP GenAI engine 106, and the content pillar 108 in system 100, may begin the process by activating a workflow initiation UI 400 in FIG. 4.

In various embodiments, the communication interface 103 may include a variety of software and hardware interface, such as a web interface, and a graphical user interface, and may facilitate multiple communications within a wide variety of networks including wireless networks, for example, WLAN, cellular or satellite, and wired networks, such as LAN, cable, etc. The communication interface 103 may be configured to have one or more ports for connecting a number of devices to another or to another server. The communication interface 103 may be configured to provide a user interface, such as the workflow initiation UI 400 in FIG. 4, for a user to interact with the system 100 to perform one or more actions authorized for the specific user assigned according to a roles component 126.

The communication interface 103 may function as an input/output (I/O) module to provide communications to or from remote systems or to the workflow initiation UI 400 from which a processor may receive a set of requirements. The system 100 may use the SmartRFP tool 166 to compose an RFP response document 164. The system 100 may then use the communication interface 103 to provide the composed RFP response document 164 as output to the user.

During operation of the SmartRFP tool 166, the RFP UI/Workflow pillar 104 may utilize UI design elements or frameworks to offer a user-friendly interface for managing the RFP process. In embodiments, the RFP UI/Workflow pillar 104 may provide a UI that is communicatively coupled to the communication interface 103 for managing the RFP process. An authorized user may access the system 100 through the communication interface 103 to provide data to the RFP UI/Workflow pillar 104. The RFP UI/Workflow pillar 104 allows users to interact with the system 100, upload documents, and track the progress of the RFP responses.

For example, the communication interface 103 may allow one or more users to feed one or more RFP documents 158 as input into the system 100 via the RFP UI/Workflow pillar 104. Inputs for composing the response documents are not limited to an RFP document. Documents other than RFP documents may be introduced into the system 100, such as financial documents and government regulatory documents.

In embodiments, the RFP UI/Workflow pillar 104 may integrate with an AI integration component 110 and a workflow service component 112 to ensure a cohesive user experience and efficient process management.

The workflow service integration component 112 may coordinate various stages of the RFP process to ensure smooth transitions between tasks and components. The workflow service integration component 112 may manage the flow of information and tasks, interacting with the RFP service API component 114 and other components to maintain process efficiency and effectiveness.

In FIG. 1, the RFP Service API component 114 may provide a standardized interface for communication between the SmartRFP tool 166 and external systems. The RFP Service API component 114 may facilitate data exchange and integration with other applications, supporting the tool's interoperability and extensibility. Interoperability is related to the SmartRFP tool's ability to operate with other applications and components. Extensibility is related to a SmartRFP tool's ability to have its functionality extended, for example, by add-ins or plug-ins. The extended functionality may be invoked and the results presented at a UI.

In an exemplary embodiment, the RFP Service API component 114 may include a comments component 116, a metadata component 118, a metrics/dashboards component 120, an audit component 122, a workflow component 124, and a roles component 126.

The comments component 116 may enable a user to provide feedback and annotations on the RFP documents. The comments component 116 may support collaboration and communication among stakeholders, integrating with the metadata component 118 and the audit component 120 to maintain a comprehensive record of changes and inputs.

The metadata component 118 may manage the metadata associated with the RFP documents, including client information, project details, and document attributes. The metadata component 118 may ensure that all relevant data is captured and accessible and support the AI integration component 110 and a personalization service component 136 in generating accurate and tailored responses.

The metrics/dashboards component 120 may provide analytical insights into the RFP process and offer stakeholders real-time data on performance and outcomes. The metrics/dashboards component 120 may support data-driven decision-making by delivering detailed reports and visualizations and integrate with a management reporting component to enhance process transparency and accountability.

The audit component 122 may maintain a detailed log of all activities and changes within the RFP process. The component 122 may ensure transparency and accountability and support compliance and quality control by enabling easy access to historical data and decision records.

The workflow component 124 may automate repetitive tasks and processes within the RFP lifecycle, reducing manual effort and minimizing errors. The workflow component 124 may leverage AI and machine learning to optimize the flow of information and tasks, ensuring that the RFP process is both efficient and effective.

The roles component 126 may manage user roles and permissions within the SmartRFP tool 166, ensuring that access to features and data is appropriately controlled. The role component 126 may support security and compliance by defining user responsibilities and access levels.

The AI Integration component 110 may interact with the RFP GenAI engine 106 which serves as one of the central parts of the SmartRFP tool 166, leveraging advanced AI algorithms to process RFP documents 158 obtained from the RFP UI/Workflow pillar 104, to extract relevant information, and to generate responses to the questions asked in the RFP documents 158. Namely, in an embodiment, the RFP GenAI engine 106 with AI capabilities may process the RFP document 158 during the RFP process to extract content from the RFP document, identify questions in the RFP document, and generate answers based on the identified questions using an authoritative repository.

In FIG. 1, the RFP GenAI engine 106 may be responsible for generating the initial draft of the RFP response. The RFP GenAI engine 106 may utilize advanced AI algorithms to produce coherent and contextually relevant answers to the identified questions, collaborating with a questionnaire extraction and content analysis component to ensure alignment with extracted questions and context.

In various embodiments, the RFP GenAI engine 106 may be configured to accept client metadata as input, which may include details such as client name, project identification (ID), etc. The RFP GenAI engine 106 may extract the content from the uploaded RFP document 158 and accurately identify the questions posed within it.

In an embodiment, the RFP GenAI engine 106 may retrieve highly precise answers from a designated authoritative repository of accurate and reliable data for each identified question. One such repository, known to those of skill in the art, is a Golden Source. The RFP GenAI engine 106 may produce generalized responses using AI techniques in cases where the Golden Source does not provide an exact answer. The RFP GenAI engine 106 may generate the RFP response document 164 in the original layout/format to ensure seamless integration with the original document.

In an embodiment, the RFP GenAI engine 106 may include a semantic search service component 128, a document generation component 130, an embedding service component 132, a document management component 134, a personalization service component 136, a layout extraction service component 138, a classification service (Q/C, Q->Metadata) component 140, an answer generation component 142, and an answer curation and finalization component 143.

The AI Integration component 110 may interact with the semantic search service component 128 and the answer generation component 142 to ensure accurate and contextually relevant outputs. The AI integration component 110 may also collaborate with the personalization service component 136 to tailor responses to specific client needs.

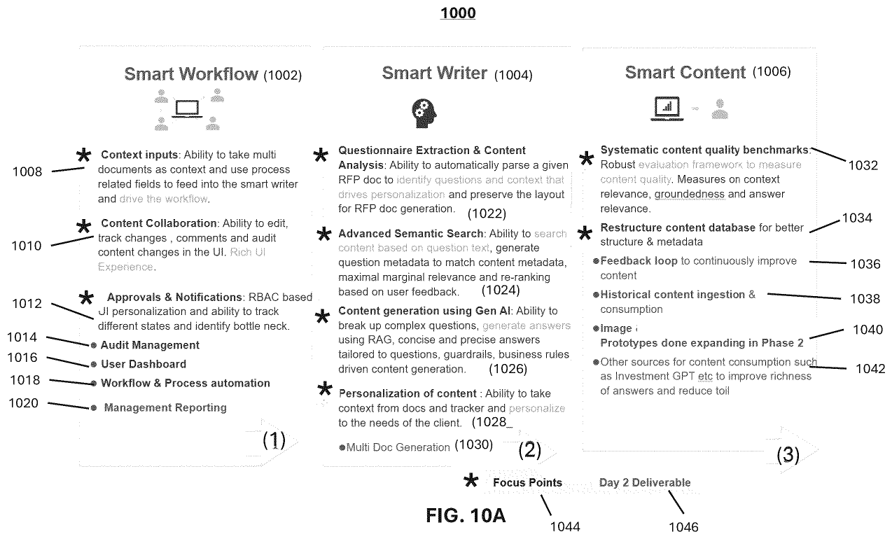

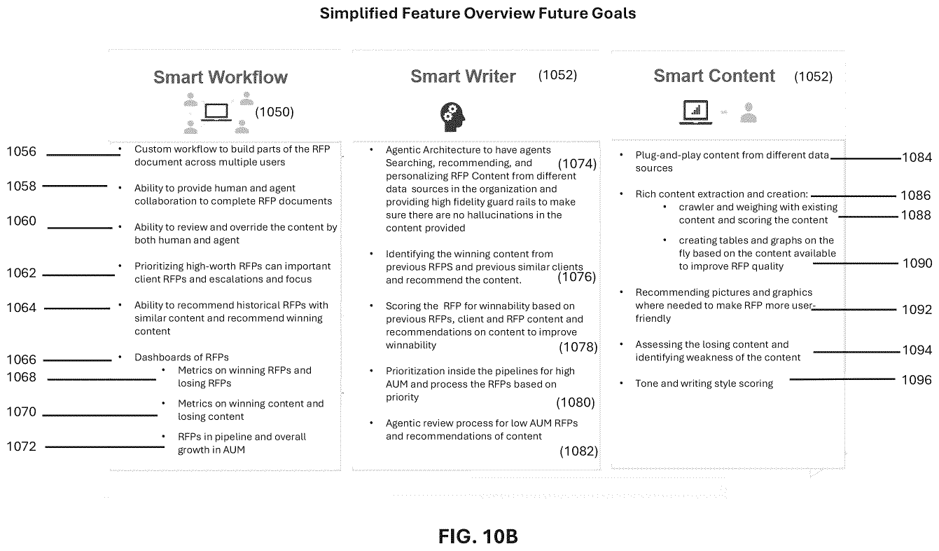

The semantic search service component 128 may enhance the ability of the RFP GenAI engine 106 to retrieve precise answers from a content repository. The semantic search service component 128 may employ search algorithms to locate the most relevant information based on the extracted questions and context, supporting a smart writer component (described in FIGS. 10A-10B) in generating high-quality responses.

The document management component 134 may oversee the storage, organization, and retrieval of RFP documents. The document management component 134 may ensure that all documents are accessible and up-to-date, supporting the overall efficiency and effectiveness of the RFP process. The document generation component 130 may automate the creation of RFP documents, ensuring consistency and accuracy across all outputs. The document management component 130 may interact with a smart content component (described in FIGS. 10A-10B) to maintain high standards of content quality and coherence.

The embedding service component 132 may process and embed data within RFP documents, enhancing the informativeness and clarity of the responses. The embedding service component 132 may collaborate with the smart writer component (described in FIGS. 10A-10B) to ensure that visual data is presented effectively.

In various embodiments, the embedding service component 132 may provide embedding techniques that represent complex data (text, images, graphs, etc.) in a simplified yet meaningful form, allowing system 100 to perform tasks like classification, prediction, retrieval, and understanding more efficiently. In various embodiments, the embedding service component 132 may apply one or more types of embedding techniques, such as word embeddings, sentence and document embeddings, image embeddings, graph embeddings, and audio and speech embeddings.

In embodiments, word embeddings may provide representations where words or phrases are mapped to vectors of real numbers in a high-dimensional space. In word embeddings, words with similar meanings are represented by vectors that are close to each other in this space. Some methods for generating word embeddings that may be used by the embodiment service component 132 may include, for example, Word2Vec, GloVe (Global Vectors for Word Representation), and FastText. In an embodiment, Word2Vec may use a shallow neural network to predict a word's context (e.g., continuous bag of words (BoW) or skip-gram models). In an embodiment, GloVe may focus on capturing global statistical information of a corpus, producing word vectors based on co-occurrence matrices. In an embodiment, FastText may be used to consider sub-word information (such as character n-grams), making it better at handling rare or misspelled words.

In embodiments, sentence or document embeddings may extend the application of word embeddings by representing larger text units such as sentences, paragraphs, or even entire documents as vectors. In some embodiments, techniques, such as Doc2Vec (which is an extension of Word2Vec) or transformer-based models, for example, bidirectional encoder representations from transformers (BERT) and GPT, may be used to generate context-aware embeddings that capture deeper meanings in the text.

In an embodiment through the application of computer vision, image embedding techniques may be used to represent images as feature vectors. For example, convolutional neural networks (CNNs) may be employed to extract feature maps from images, which may then be reduced into compact embeddings. These embeddings may be used, in embodiments, for tasks involving image retrieval, classification, and object detection. In some embodiments, pre-trained models like ResNet® and visual geometry group (VGG) may be used for generating image embeddings.

In embodiments through the application of graph theory, embedding techniques may map the nodes or edges of a graph into a lower-dimensional space. System 100 may use graph embedding techniques in network analysis, recommendation systems, and social network analysis. In embodiments, methods like Node2Vec, DeepWalk™, and graph convolutional networks (GCNs) may be used to create graph embeddings that preserve the structural information of the graph.

In embodiments applying audio and speech embeddings, similar to text and images, audio signals may be transformed into embeddings. Techniques, such as mel-frequency cepstral coefficients (MFCCs) and deep learning-based models (e.g., long short-term memory (LSTM) or transformers), may be used to convert speech signals into vector representations that may be used for speech recognition, speaker identification, and sentiment analysis.

In FIG. 1, the layout extraction service component 138 may extract and analyze the layout of RFP documents, ensuring that the structure and format are preserved during processing. The layout extraction service component 138 may support the AI integration component 110 and the document generation component 130 in maintaining document integrity.

The classification service (Q/C, Q->Metadata) component 140 may categorize questions and context within RFP documents, employing natural language processing techniques to accurately extract relevant information. The classification service (Q/C, Q->Metadata) component 140 may play a role in ensuring that the GenAI engine understands the document's structure and content.

The answer generation component 142 may leverage generative AI models to create personalized and contextually appropriate RFP responses. The answer generation component 142 may ensure that the generated content is accurate and tailored to the specific needs and preferences of the client. The personalization service component 136 may focus on tailoring the RFP responses to meet the requirements and expectations of the client. The personalization service component 136 may utilize client-specific data and preferences to adjust the tone, style, and content of the responses, working closely with the content generation using a GenAI component.

In FIG. 1, the system 100 may include the persistent store integration component 144 configured to store data. The persistent store integration component 144 may manage the storage and retrieval of data within the system 100, ensuring that all information is securely stored and easily accessible. The persistent store integration component 144 may support the overall architecture by maintaining data integrity and availability. The system 100 may include one or more processors (not shown) to control the operation, such as writing data to or reading data from the persistent store integration component 144.

The persistent store integration component 144 herein refers to a “persistent database” which may be any database that stores data in a way that it remains accessible even after the application is closed or the system is restarted, essentially meaning the data persists on a storage device. The persistent databases may use storage, such as hard disk drives (HDDs), solid-state drives (SSDs), or cloud storage services to store data persistently. The persistent store integration component 144 may include one or more persistent databases, for example, relational databases (e.g., MySQL®, PostgreSQL®), NoSQL databases (e.g., MongoDB®), object-oriented databases (e.g., ObjectDB), hierarchical databases (i.e., data organized in a tree-like structure), and embedded databases (e.g., SQLite®).

FIG. 1 shows three examples of persistent databases of the persistent store integration component 144, including a vector database component 146, a relational database service (RDS) component 148, and a simple storage service (S3™) component 150, which may be used alone or in combination by the system 100.

The vector database component 146 may facilitate the processing and analysis of vector data within the system 100. The vector database component 146 may support the AI integration component 110 and the semantic search service component 128 in handling complex data structures and enhancing response accuracy. The vector database component 146 may be configured as a database designed to store and manage vector embeddings, which are mathematical representations of data in a high-dimensional space.

A vector's position in the high-dimensional space represents its characteristics. Words, phrases, or entire documents, and images, audio, and other types of data may all be vectorized. These vector embeddings may be used in similarity search, multi-modal search, recommendations engines, large language models (LLMs), etc. The vector embeddings may be indexed and queried through vector search algorithms based on their vector distance or similarity. The vector database 146 may include one or more vector databases, such as Pinecone® or Google Cloud's Matching Engine®.

The RDS component 148 may provide a relational database service for managing structured data within the system 100. The RDS component 148 may support data storage, retrieval, and management, ensuring that all information is organized and accessible. The RDS component 148 may provide a cloud-based service that offers managed relational databases that are configured to store, manage, and query data in structured formats using tables, rows, and columns. The RDS component 148 may include a plurality of tables, each with a set of columns corresponding to different fields or types of values stored in rows or records. Example relational databases that may be employed in the system 100 herein include, such as Amazon RDS®, Google® Cloud SQL, and Azure® SQL Database.

The S3™ component 150 is a scalable, high-speed, web-based cloud storage service provided by AWS, or similar. The S3™ component 150 may be configured as an object storage service for storing and retrieving any amount of data, at any time, from anywhere on the web. The S3™ component 150 may offer scalable object storage for unstructured data within the system 100. The S3™ component 150 may support the storage and retrieval of large volumes of data, enhancing the tool's capacity to handle diverse data types and formats. The S3™ component 150 may be designed to be highly durable, reliable, and secure, and it may be used for a variety of applications such as backup, data archiving, content distribution, and big data analytics.

In FIG. 1, an Open AI Integration component 152 may connect the SmartRFP tool 166 with external Open AI services 154, expanding the tool's capabilities and enhancing the ability of the SmartRFP tool 166 to generate high-quality responses. The Open AI Integration component 152 may support the AI Integration component 110 and the personalization service component 136 in delivering tailored and effective RFP response documents 164 as outputs.

A VPC component 156 may provide a secure and scalable environment for hosting the SmartRFP tool 166, for example, on an Azure cloud platform. One exemplary VPC is an Azure VPC. The VPC component 156 may ensure secure communication and resource management, supporting the overall architecture of the tool.

The VPC component 156 may provide Open AI services, such as AI, ML, and Open AI technologies incorporated within the Open AI services component 154. For example, the Open AI services may provide a natural language processing (NLP) tool driven by AI technology that allows users to conduct human-like conversations with a chatbot to answer questions and assist with tasks, such as composing text for drafting the RFP response document 164.

In FIG. 1, the Open AI services component 154 (e.g., Azure Open AI) may integrate AI capabilities with the SmartRFP tool 166, enhancing the tool's ability to process and analyze RFP documents. The AI capabilities may be used to retrieve, process, and analyze data from various sources, including “big data” which may exist in many industries, including financial; medicine; research and development; software development, including writing and debugging code; and document drafting, including writing RFP response documents 164 and other documents such as legal documents and government regulations. The Open AI services component 154 may support the AI Integration 110 and the answer generation component 142 in delivering accurate and contextually relevant responses.

As shown in FIG. 1, the content pillar 108, which is included as a component of the SmartRFP tool 166, may perform content extraction 170 for processing RFP documents 158 to extract relevant information and context. This component supports the AI integration component 110 and the classification service component 140 in understanding the document's structure and content. The content pillar 108 may include the ICM component 160 and a DocStore component 162.

The ICM component 160 may serve as a content management system, overseeing the organization and retrieval of content within the SmartRFP tool 166 and the system 100. The ICM component 160 may ensure that all content is accessible and up-to-date, supporting the overall efficiency and effectiveness of the RFP process.

The DocStore component 162 may provide a centralized repository for storing and managing RFP documents. The DocStore component 162 may ensure that all documents are securely stored and easily accessible, supporting the overall architecture of the system 100.

In various embodiments, an authoritative repository, such as Golden Source, as discussed above, for retrieving precise data and ensuring consistency and accuracy in responses, may be included as a repository of the ICM component 160. In one example, original vetted data in the ICM component 160 may be the Golden Source. As an initial consideration, training data used for the SmartRFP tool 166 may include a golden set of sources to ensure its suitability and representativeness. For instance, the methodology of system 100 may use the Golden Source of data for retrieval-augmented generation (RAG) indicators.

The answer curation and finalization component 143 may involve reviewing and refining the generated RFP responses 164. The answer curation and finalization component 143 may ensure that all responses undergo necessary checks and receive the required endorsements before finalization of the RFP response document 164. The AI answer curation and finalization component 143 may work in conjunction with the audit component 122 to track changes and approvals, maintaining a record of all modifications and decisions made during the RFP process.

The downstream review/operations component 168 may provide the final review and approval of RFP responses. The downstream review/operations component 168 may be configured to review, finalize, and approve the RFP response document 164 downstream. The downstream review/operations component 168 may ensure that all responses meet the necessary criteria and standards before being finalized. The downstream review/operations component 168 may collaborate with the audit component 122 to maintain a detailed log of all actions taken, supporting compliance and quality control.

In summary, in FIG. 1, the present disclosure provides system 100 to implement the herein disclosed SmartRFP tool 166. The system 100 may include a computer program, which may be stored on non-transient computer-readable storage medium and includes one or more modules. One or more processors may access the computer program, upload all or portions of the computer program to memory and execute machine instructions or scripts associated with the uploaded program. The modules may be invoked to execute the herein disclosed methods. The modules may work together to retrieve, process, and analyze data retrieved or accessed from data sources. The processors may use various libraries such as Open AI, embedding, operating system (OS), JavaScript Object Notation (JSON), Pathlib, Library for extensible Markup Language (LXML), Comma Separated Values (CSV), pandas, Pinecone®, and more.

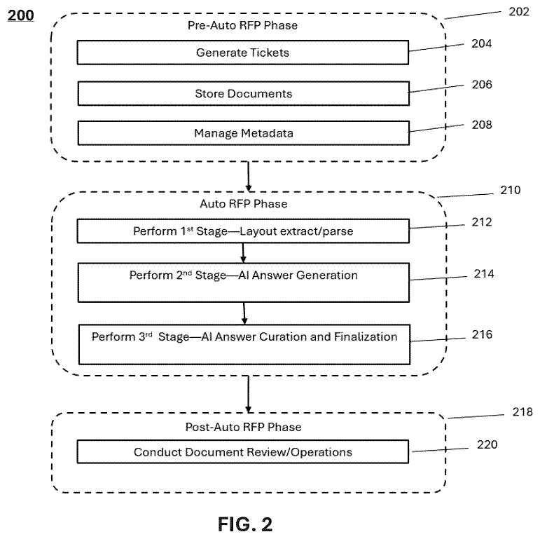

FIG. 2 is a high-level flow diagram illustrating an example end-to-end method 200 for generating the RFP response document 164 using an automated AI-assisted RFP response tool described with reference to FIG. 1. As depicted in FIG. 2, the method 200 may comprise three phases, including a pre-auto RFP phase 202, an Auto RFP phase, and a Post-Auto RFP phase 218.

The Pre-auto RFP phase 202 utilizes the RFP service API component 114 to initiate the RFP method 200 by managing the initial stages of document handling and metadata collection. The Pre-auto RFP phase 202 ensures that all necessary information is gathered before the automated RFP process begins.

At step 204, a ticket may be generated when an RFP document 158 is received at system 100 on a UI through the communication interface 103. The RFP document 158 is then transferred to the RFP UI/Workflow pillar 104. In an embodiment, the RFP UI/Workflow pillar 104 may include an issue tracking system (not shown), such as JIRA, that functions as a tracking and management system for the RFP requests. The issue tracking system organizes and prioritizes the RFPs based on various criteria, ensuring that each request is processed efficiently.

For example, in Jira, teams may use issues, also known as tickets, to track individual pieces of work items. When the user submits a request to the system 100 to prepare a response to the RFP document 158 through the communication interface 103, the request automatically becomes a ticket that may be used to track the analysis and servicing of the request.

FIG. 4 is an example illustration of a workflow initiation UI 400 for uploading user RFP documents 158 in accordance with the embodiments. The embodiments provide SmartRFP tool 166, an automated AI-assisted RFP response tool where one team may initiate the RFP response process, and writers from another team prepare the RFP response drafts.

The example workflow initiation UI 400 may streamline the process of generating RFP responses. The SmartRFP application may follow the motto of “Document In-Document Out,” which means that the RFP questionnaire 158 may be used as input to generate the RFP response document 164. The “Document In-Document Out” process receives the RFP document 158 into the workflow of the system 100, makes any necessary changes or actions on it, and then sends it back out to another person or system. Namely, the RFP document is “checked in” for processing and then “checked out” once completed.

The workflow initiation UI 400 may initiate an example workflow for the “Document In-Document Out” process as follows where the user uploads the RFP questionnaire document 158 to the application. The uploaded document is then processed by the RFP GenAI engine (i.e., the AI pillar) 106 (as discussed above).

In embodiments, one of the goals of the end-to-end RFP workflow and RFP generation application may be to simplify and automate the process of generating RFP responses. By leveraging AI technology and following a “Document In-Document Out” approach, the application ensures efficient, accurate, and personalized results for RFP questionnaires.

As depicted in the example workflow initiation UI 400 of FIG. 4, smart RFP inputs may facilitate uploading the RFP document 158 and enable a standard database of answers.

The workflow initiation UI 400 may include visual, graphical, or interactive elements that allow a user to interact with the system 100. The workflow initiation UI 400 may be configured for human input and output, for example, a screen, buttons, or menus on a device, enabling the user to send and receive information through a communication channel. In an embodiment, the workflow initiation UI 400 may allow users to easily monitor and interact with real-time data during the preparation of the RFP response document 164.

In FIG. 4, a ticketing initiation dashboard 412 of the workflow initiation UI 400 provides a graphical user interface that is displayable to the user and automates the “Doc In-Doc Out” process. The ticketing initiation dashboard 412 may serve as a central hub for users to initiate the RFP generation process by uploading the RFP document 158.

In one implementation, the ticketing initiation dashboard 412 may include a number of user input fields that receive user input to configure the creation of the ticket. In an exemplary embodiment in FIG. 4, the ticket may include a standardized template that facilitates issue tracking and monitoring. In an example, the standardized template may include user input fields containing, for example, overview information 402, requestor's details information 404, team information 406, an RFP document box 408, and an action list 410.

The overview information 402 may include a ticket number, the status of the request, the stage of drafting the RFP response, a field for the name of the RFP writer, the created date, and a field for the name of the initiator.

The requestor's details information 404 may include information, such as the name of an organization, size of the opportunity, RFP publish date, organization type, etc.

The team information 406 may include information related to, for example, banker/advisor information, market information, Outsourced Chief Investment Officer (OCIO) Investment specialist, etc.

The RFP document box 408 enables a user to select and upload one or more RFP document files to the system which may be displayed as a list, an icon, or a symbol within RFP document box 408.

The action list 410 may be provided for the user to select one or more actions to be performed. The action list 410 may include, for example, Step 1—RFP document extraction process; Step 2—RFP document parsing process; Step 3—Annotation of RFP questions; Step 4—AI Answer generation; and Step 5—Refinement of AI Answers.

Returning to FIG. 2, at step 206, the RFP documents 158 may be stored in one or more databases of the persistent store integration component 144 after being received and processed in the RFP UI/Workflow pillar 104. In the RFP UI/Workflow pillar 104, a documents component (not shown) may handle the storage and organization of RFP documents. The RFP UI/Workflow pillar 104 interfaces with the metadata component 118 to ensure that all relevant information is captured and accessible throughout the RFP process.

The documents component of the RFP UI/Workflow pillar 104 may ensure that documents are easily accessible and up-to-date, supporting the overall efficiency and effectiveness of the RFP process. The documents component may interact with the metadata component 118 to maintain a comprehensive record of document attributes and details, facilitating seamless integration with other components in the system.

At step 208, the process may manage the metadata associated with RFP documents, including client information, project details, and document attributes using the metadata component 118. The metadata component 118 may ensure that all relevant data is captured and accessible and support the AI integration component 110 and a personalization service component 136 in generating accurate and tailored responses.

The Pre-auto RFP phase 202 may support the overall workflow by providing an initial structured approach to managing RFP requests. During the pre-auto RFP phase 202, the RFP UI/Workflow pillar 104 processes the tickets and documents to organize and prepare the RFP data for further processing. The pre-auto RFP phase 202 may play a role in setting the stage for a seamless transition into the automated workflow.

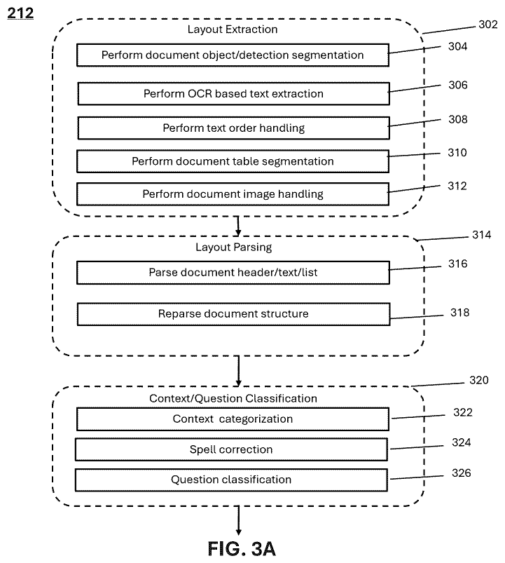

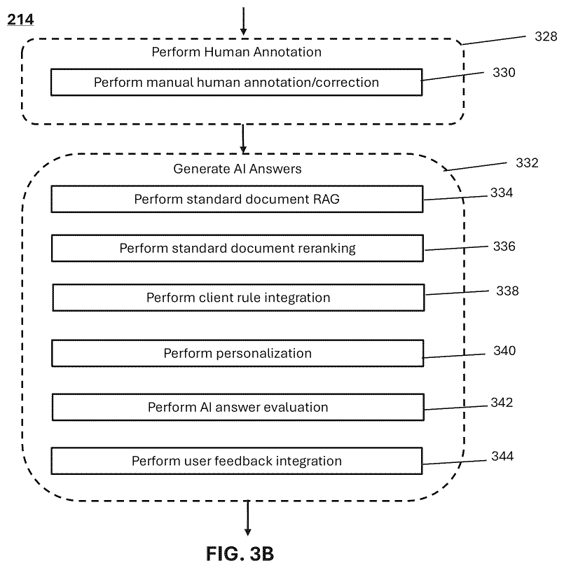

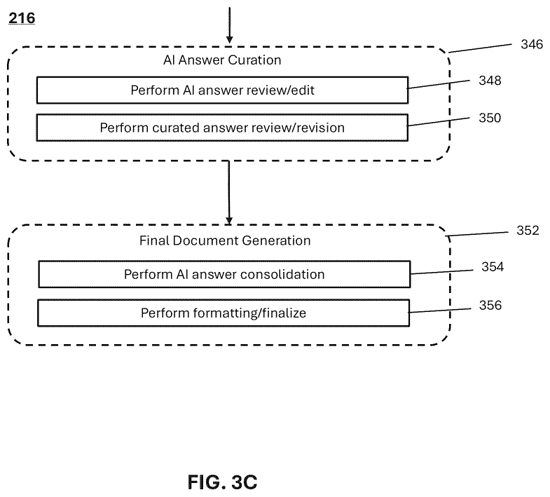

In FIG. 2, after the pre-auto RFP phase 202, the uploaded document is then transferred for processing in the Auto RFP phase 210 by the RFP GenAI engine (i.e., the AI pillar) 106. In an embodiment, the RFP GenAI engine (i.e., the AI pillar) may utilize various components shown in FIG. 1, such as the layout extraction service component 138, the classification service (Q/C, Q->Metadata) component 140, and the answer generation component 142 to implement the Auto RFP phase 210. The Auto RFP phase 210 represents a detailed workflow of the automated RFP process and may include a first stage-layout extract/parse at step 212 (as described in detail in FIG. 3A below), a second stage-AI answer generation at step 214 (as described in detail in FIG. 3B below), and a third stage-AI answer cure ration and finalize at step 216 (as described in detail in FIG. 3C below).

In general, the Auto RFP phase 210 represents the central part of the automated RFP process. The Auto RFP phase 210 encompasses several stages, including layout extract/parse, AI answer generation, and AI answer curation and finalization. The Auto RFP phase 210 leverages advanced AI algorithms to process RFP documents, extract relevant information, and generate responses. This component interacts with various other components to ensure a seamless and efficient RFP workflow.

At step 212, the first stage layout extract/parse may focus on analyzing the layout of RFP documents. The layout extract/parse stage extracts and processes the document structure, ensuring that the format and organization are preserved during processing. This stage supports the AI integration component 110 and the document generation component 130 in maintaining document integrity and facilitating accurate information extraction. The steps of the layout extract/parse stage will be described in detail in FIG. 3A below.

In particular, smart RFP extraction services may be provided at step 212 in the layout extract/parse stage to offer innovative service that enhances the extraction and classification of information from RFP documents. In an embodiment, the smart RFP extraction service may implement parallel processing of portable document format (PDF) files. In embodiments, the smart RFP extraction service may also convert the contents into a structured layout similar to that of deep document detection techniques. The smart RFP extraction service may employ a variety of algorithms and artificial intelligence technologies to classify each section of the document into questions, headings, or context.

At step 212, within the layout extract/parse stage, the smart RFP extraction and classification service may process RFP documents in parallel, leveraging various techniques to convert, classify, and understand information within the document. This may enhance the efficiency and accuracy of interpreting complex RFPs. For instance, parallel processing of PDF files may enable the service to read all pages of a PDF document simultaneously using parallel processing algorithms, significantly reducing the time required for initial data extraction.

In step 212, through the use of a conversion to a structured layout technique, the extracted data may then be converted into a structured format similar to deep document detection, where each element on the page may be parsed and presented in a format that mirrors the original layout.

With positional analysis applied during the extraction process in the layout extract/parse stage at step 212, the system 100 may analyze the position of statements on the page of the RFP document, using heuristics to determine their likely classification. Elements at the top of a section are more likely to be headings, while indented or bullet-pointed items may be questions or additional context.

In embodiments at step 212, the extraction process may use a bullet points identification technique that deploys specific algorithms to scan for bullet points and lists, recognizing these as potential indicators of segmented information, which often includes questions or detailed specifications.

At step 212, various embodiments may employ table detection, which is a computer vision technique, to identify the location of a table within an image. Advanced pattern recognition algorithms may detect tables, extracting both the structure and content, and classifying whether they contain critical data or context information.

At step 212, AI-based classification prompts may be used to present the AI with input and ask it to classify the input using predefined labels or categories. The extraction service within the layout extract/parse stage may employ generative AI to further classify segments. This may involve running classification prompts to determine if a segment is a question, heading, or context based on its content and surrounding elements.

After the extraction and annotation processes are completed, the question and answer (Q&A) phase may begin at the second stage AI answer generation in step 214. This step may include breaking down the original questions (parent) into multiple parts, rephrasing them, and matching them against a pre-defined list of topics. The answers may be retrieved through a series of advanced techniques, utilizing embeddings and machine learning models for maximum accuracy.

At step 214, the second stage AI answer generation may leverage generative AI models to create personalized and contextually appropriate RFP responses. The second stage AI generation may ensure that the generated content is not only accurate but also tailored to the specific needs and preferences of the client. The AI answer generation stage may collaborate with the personalization service component 136 to deliver customized responses that enhance the overall quality and relevance of the RFP. The steps of the AI answer generation stage will be described in detail in FIG. 3B below.

For instance, at step 214, the AI answer generation stage may enhance the Q&A capabilities within the RFP Gen AI Engine 106. At step 214, the process may include decomposing questions into multiple SQs, rephrasing them, and classifying topics. Questions may be converted into embeddings, and Maximum Marginal Relevance (MMR) may be used to identify the most relevant answers from a golden repository. The top answers may be further refined and personalized using AI techniques, ensuring precise and contextually accurate responses.

At step 214, to implement the Q&A, the second stage AI answer generation may integrate various technologies to decompose, rephrase, and precisely answer questions derived from RFP documents. For example, at this step, the process may utilize topic classification, embedding conversion, MMR for answer relevance, and AI-based answer generation for personalized responses.

For example, at step 214 in the AI answer generation stage, question decomposition and rephrasing models may generate reasoning by decomposing questions into SQs. At step 214, during the AI answer generation stage, system 100 may break down complex questions into multiple simpler SQs and rephrase them in various ways, ensuring comprehensive coverage.

By performing topic classification at step 214, the rephrased SQs may be classified into predefined topics using machine learning classification models.

An embedding conversion technique at step 214 may convert each rephrased SQ into embeddings (i.e., vector representations) for computational analysis. In embodiments, at step 214, MMR may be utilized with thresholding to assess and compare the relevance of embeddings (from both question and golden repository content) to identify the most pertinent answers.

Another technique that may be applied at the AI answer generation stage in step 214 is an append preferred answers technique. Based on feedback from the users, preferred answers may be appended to a list of all highly relevant answers.

In embodiments, high-relevance answers may be selected based on their MMR scores, ensuring the inclusion of highly recommended responses.

Various embodiments of the AI answer generation stage at step 214 may use a re-ranking with Generative Pre-trained Transformers (GPT™). GPT™ may be used to re-rank the selected answers, prioritizing those with the highest relevance.

During AI answer generation at step 214, personalized AI answers may be generated by integrating the context summary from the extraction step and merging the answers of the SQs for a cohesive, comprehensive response.

After the questions and answers are generated, the AI answer curation and finalization may begin at step 216. At step 216, the third stage AI answer curation and finalization may involve reviewing and refining the generated RFP responses. This stage may ensure that all responses undergo necessary checks and receive the required endorsements before finalization. The AI answer curation and finalization stage may work in conjunction with the audit component 122 to track changes and approvals, maintaining a record of all modifications and decisions made during the RFP process. The steps of the AI answer curation and finalization stage will be described in detail in FIG. 3C below.

By way of example only, and not limitation, the process of the Auto RFP phase 210 may involve various steps, including the RFP GenAI engine (i.e., the AI pillar) 106 (a) extracting content from the uploaded RFP document 158 and (b) analyzing the extracted content to identify the questions being asked and the context in which they are presented. After the RFP GenAI engine (i.e., the AI pillar) 106 processes the RFP document 158, there may be a stage of human and/or automated review and approval. This step ensures the accuracy and quality of the generated RFP response document 164.

More specifically, FIGS. 3A-3C illustrate a low-level flow diagram of an example end-to-end process of the Auto RFP phase 210 using the automated AI-assisted RFP response tool 166 described with reference to FIG. 1. FIGS. 3A-3C illustrate the stages of the first stage—layout extract/parse at step 212 (as described in detail in FIG. 3A below), the second stage—AI answer generation at step 214 (as described in detail in FIG. 3B below), and the third stage—AI answer cure ration and finalize at step 216 (as described in detail in FIG. 3C below). Although the process is described as a continuous process, it may be segmented into smaller processes that run concurrently or in sequential stages.

After the pre-auto RFP phase 202 in FIG. 2, the uploaded document may then be transferred to the Auto RFP phase 210 for processing by the RFP GenAI engine (i.e., the AI pillar) 106 beginning at the first stage-layout extract/parse at step 212 described in FIG. 3A. During the Auto RFP phase 210, the document management component 134 may oversee the storage, organization, and retrieval of RFP documents in the RFP GenAI engine (i.e., the AI pillar) 106. The document management component 134 may ensure that all documents are accessible and up-to-date, supporting the overall efficiency and effectiveness of the RFP process.

In FIG. 3A, at step 212, the stages of the first stage-layout extract/parse may involve multiple steps including layout extraction at step 302, layout parsing at step 314, and context/question classification at step 320. In an embodiment, the layout extraction at step 302 may be performed utilizing the layout extraction service component 138.

At step 302, the layout extraction analysis performed by the layout extraction service component 138 may analyze and segment a document to extract regions of interest and their inter-relationship. The goal of the layout extraction analysis is to extract text and structural elements from the page to build better semantic understanding models. The layout extraction analysis may involve multiple steps to extract meaningful data and structure. At step 302, the layout extraction analysis may use the layout extraction service component 138 to extract and analyze the layout of RFP documents, ensuring that the structure and format are preserved during processing.

At step 304, a document object/detection segmentation may be performed to identify and segment key areas in the document, such as text blocks, images, tables, and other objects using the layout extraction service component 138. In an example approach, at step 304 during the document object/detection segmentation process, the layout extraction service component 138 may first apply image preprocessing techniques, such as binarization, noise removal, and thresholding to enhance the document's quality.

At step 304, object detection may be performed using computer vision techniques such as CNNs or region-based convolutional networks (R-CNNs) to identify regions of interest (ROIs) in the document. The ROIs may include, for example, text blocks, images, tables, titles, headers, and footers. The layout extraction service component 138 may segment the document into its constituent components (e.g., paragraphs, columns, tables, images). This step enables further analysis and service of the request, as it provides the structural map of the document.

At step 306, the process may include performing optical character recognition (OCR) based text extraction to extract the content from the uploaded document and accurately identify the questions posed within it. At step 306, the layout extraction service component 138 may extract readable text from the segmented regions of the document. In an example approach, at step 306, the OCR-based text extraction process may include applying OCR tools, such as Tesseract® or Google® Vision OCR, to extract text from the identified text regions. The OCR tool may convert image-based text into machine-readable format.

At step 308, the layout extraction service component 138 may perform text order handling to reconstruct the logical flow of text from different regions, especially when dealing with multi-column or multi-page documents. During the text order handling process, at step 308, the layout extraction service component 138 may analyze the document layout to establish the reading order. For example, in a multi-column layout, the layout extraction service component 138 may need to distinguish which text belongs to the first column and which belongs to the second.

At step 308, the layout extraction service component 138 may, for example, implement heuristics or use machine learning algorithms to infer the correct order based on the document's layout structure. This step may include handling headers, footers, and page numbers. After the reading order is established, the system 100 may perform text reconstruction to reassemble the extracted text into a coherent document.

At step 310, the layout extraction service component 138 may perform document table segmentation to identify and segment tables from the document for further analysis using the layout extraction component 302. In an example approach, at step 310, the layout extraction service component 138 may use techniques, for example, connected component analysis or deep learning models trained to detect table structures, such as TabNet or other table recognition models. These methods may help to detect rows, columns, and borders that define tables.

At step 310, in cases of tabular data without clear borders, a grid-based segmentation approach may be applied by the layout extraction service component 138 to detect the spatial arrangement of rows and columns. After the table structure is detected, the layout extraction service component 138 may extract each cell's content using OCR, ensuring that the data is preserved in a structured format (e.g., CSV or JSON). At step 310, the layout extraction service component 138 may clean up any inaccuracies caused by OCR or table segmentation errors, such as misaligned rows or incorrectly split cells.

At step 312, the layout extraction service component 138 may perform document image handling to identify, segment, and handle images within the document, ensuring that images are not mistaken for text or other objects. In an example approach, at step 312, the layout extraction service component 138 may use image detection algorithms (e.g., CNNs or deep learning-based models) to identify regions containing images within the document. These images may be, for example, logos, graphs, charts, or photographs.

At step 312, after the images are detected, the layout extraction service component 138 may separate the images from text-based content. This step ensures that any text embedded in images is not processed with the text extraction methods but handled separately (e.g., by using OCR on the image itself). In an embodiment, if necessary, the layout extraction service component 138 may preprocess the images (e.g., resizing, filtering) for further analysis or extraction. At step 312, if the document includes diagrams or graphs, they may require additional interpretation or processing to extract useful data (e.g., using image analysis or graph recognition techniques). At step 312, the layout extraction service component 138 may store the extracted images separately in formats, such as PNG or JPEG, while the metadata (such as image location and description) may be stored in a structured format for further reference.

In embodiments, through the implementation of workflow integration, steps 304-312 of the layout extraction process in FIG. 3A may be connected to a larger document analysis pipeline. After each step, the results from previous stages may be used as input to the next, allowing for iterative refinement and enhancement of the document's segmentation and extraction. After all segments of the document (text, tables, images, etc.) have been processed, the final document structure may be output in a structured format, such as XML, pdf

, or a relational database format that preserves both the visual layout and the extracted information. According to the present disclosure, this multi-step process included in the layout extraction process at step 302 ensures that documents, no matter how complex, may be broken down into structured components, allowing for detailed analysis and easier data extraction.

The final document structure may be output in a structured format such as hypertext markup language (HTML), extensible markup language (XML), JSON, or relational database format from the layout extraction process at step 302 and received as input at the layout parsing process at step 314 in FIG. 3A.

In FIG. 3A, at step 314, the layout parsing process using the layout extraction service component 138 may extract document content elements, such as text, tables, and lists, and create context-aware chunks that facilitate information retrieval in generative AI and discovery applications. The layout parsing process may include the steps of (1) document header/text/list parsing at step 316 and (2) document structure reparsing at step 318. In general, during the layout parsing process in step 314, the document may be first analyzed for key components (header, body text, lists, etc.), and then the overall structure may be re-analyzed to refine or correct the initial parsing based on insights gained during the first analysis.

In various embodiments, during the layout parsing process at step 314, the layout extraction service component 138 may be configured to parse all file types, for example, PDF, HTML, document file XML (DOCX), PowerPoint Open XML (PPTX), and Microsoft Excel Spreadsheet (XLSX). The layout extraction service component 138 may control content parsing by specifying the type of parsing to apply to the content when the document is uploaded. In various embodiments, the layout extraction service component 138 may implement the parsing process using a layout parser tool, such as Google® Vertex AI™ Search. In an embodiment, the Google® Vertex AI™ Search may include a digital parser which may be used as the default for all file types, an OCR parser for PDFs, and a layout parser for HTML, PDF, or DOCX files.

At step 316, the document header/text/layout parsing process parses the document layout and identifies the different structural components (e.g., headers, body text, and lists) using the classification service 140 in FIG. 1. The layout analysis may be based on visual clues (spacing, font sizes, markup) to classify and label these elements. Specifically, the document header/text/layout parsing process may detect the layout, for example, for an HTML, XML, JSON or PDF document. Then, the document header/text/layout parse process may identify content elements, such as text blocks, tables, lists, and structural elements, such as titles and headings, and use them to define the organization and hierarchy of the document.

At the completion of the document header/text/list parsing process at step 316, the document structure has been segmented into key sections: header, body text, and lists.

At step 318, during the document structure reparsing process, the document's structure may be re-examined or re-processed to refine the classification and correct any mistakes or inconsistencies that may have occurred during the document header/text/layout parsing process at step 316. Using the layout extraction service 138 in FIG. 1, the document structure reparsing process at step 318 may ensure that the document's content is interpreted accurately, especially when initial layout parsing may be ambiguous. During the reparsing process at step 318, the layout extraction service component 138 may review the initial segmentation and adjust/reassign incorrectly labeled sections. The layout extraction service component 138 may also refine the hierarchical structure, ensuring that headings, sub-headings, and content are properly grouped.

At step 318, the document structure reparsing process may perform error correction and refinement to revisit ambiguous or unclear sections of the document, particularly where the initial layout parsing may have misclassified content. For instance, a block of text that was initially identified as a header may actually be part of the body text, or a list may have been incorrectly split into multiple lists. The error correction and refinement may also correct mistakes using additional heuristics or machine learning models trained on the document layout to improve classification (e.g., identifying whether a header actually belongs at the top of the section or if it is part of the main body).

At step 318, the document structure reparsing process may perform a structural consistency check to recheck the overall document layout for consistency. If any sections are missing, misaligned, or misplaced, the parser may attempt to fix them. For example, if a list item has been misidentified as separate from the list, the reparsing step 318 may identify and correct this inconsistency. In cases where more complex nested structures are present (e.g., nested lists, tables with lists inside them), the reparsing step 318 may analyze these intricate relationships and reassign components into their correct places within the document's hierarchy.

At step 318, the document structure reparsing process may also perform contextual refinement to leverage contextual information gathered during initial parsing (e.g., headers and body text associations) to re-evaluate sections that may have been misclassified earlier. If a block of text appears to be a paragraph with no header, but it follows a header contextually, it may be recategorized. The document structure reparsing process may use advanced algorithms, such as NLP to determine if a paragraph is part of a larger section (e.g., aligning text with a header, identifying subsections of text, etc.).

At step 318, the document structure reparsing process may re-check layout features. The document structure reparsing process may reparse features, such as page breaks, columns, or multi-column layouts. For documents with complicated layouts (e.g., complex RFP or academic papers), the structure may need to be re-examined based on additional clues, such as font consistency, paragraph alignment, or graphic elements. The document structure reparsing process may use machine learning models to detect and reformat complex layouts, such as distinguishing between content types (e.g., differentiating a table from a list) or re-aligning segmented content that should be part of the same section.

The parsed document structure may be transferred as output from the layout parsing process at step 314 and received as input at the context/question classification process at step 320 in FIG. 3A.

At step 320, the context/question classification process using the classification service (Q/C, Q->Metadata) component 140 may establish the domain or context, ensure text quality through spell correction, and then categorize the question type for effective information retrieval or answer generation. At step 320, the context/question classification process may include the steps of (1) context categorization at step 322, (2) spell correction at step 324, and (3) question classification at step 326.

At step 322, the context categorization process may be performed by categorizing the context in which the question is posed. The context categorization process helps to understand the domain or intent behind the question. One of the goals of the context categorization process may be to classify the question into a specific context or domain (e.g., finance, sports, technology, health) based on the surrounding text or metadata. This step is important to disambiguate questions and align them with relevant knowledge sources or question-answering models.

At step 322, the context categorization process may include text preprocessing to tokenize the input text, when it is a sentence or paragraph, into words or sentences. The context categorization process may perform feature extraction to extract features from the context. Using one or more NLP techniques during the context categorization process, the classification service (Q/C, Q->Metadata) component 140 may employ, for example, a BoW model that counts the occurrences of words in a document, while ignoring their order, and a term frequency-inverse document frequency (TF-IDF) method to refine the BoW by weighting words based on their frequency within a document and rarity across a corpus.

At step 322, in an embodiment, using another NLP technique to extract the features, the classification service (Q/C, Q->Metadata) component 140 may use the vector database 146 to apply word embeddings technique, for example, Word2Vec or GloVe, to represent words as vectors capturing semantic relationships between words. As another example, the classification service (Q/C, Q->Metadata) component 140 may utilize n-grams or syntactic features, such as dependency parsing, to analyze sequences of words (N-grams) or grammatical relationships to understand context and meaning within a sentence. For instance, dependency parsing may be used to examine the dependencies between the words of a sentence to analyze its grammatical structure.

Further at step 322, to generate the context generation, the classification service (Q/C, Q->Metadata) component 140 process may use machine learning models, such as Naive Bayes, a support vector machine (SVM), or deep learning models (e.g., CNN or LSTM networks) for text classification or pretrained models (e.g., BERT or GPT™) for contextual understanding. Then, the machine learning models may output a category label (e.g., finance, sports, technology, medicine).

After the context is categorized at step 322, the spell correction process may be implemented by the classification service (Q/C, Q->Metadata) component 140 at step 324 to ensure that the question is free from spelling errors or typographical errors that may affect classification and understanding. The spell correction process may improve the quality of the input text for the classification model by reducing noise. By discarding stop words, which may include articles, prepositions, and other frequently occurring words (e.g., “a,” “the,” “in”), the classification service (Q/C, Q->Metadata) component 140 may reduce noise so that the system may instead focus on content-rich terms in the document.

At step 324, during the spell correction process, the classification service (Q/C, Q->Metadata) component 140 may use a spell checking algorithm tool (e.g., SymSpell, Hunspell, or Pyspellchecker) to detect and correct misspelled words. To perform contextual spell correction, the system 100 may use a deep learning model, such as BERT, for spelling correction that may also consider the context in which the word appears. In embodiments, these models may detect individual spelling errors and also misused words (e.g., “there” vs. “their”). At step 324, after applying the spell checking algorithm tool, the classification service (Q/C, Q->Metadata) component 140 may perform a post-correction review to verify the correction by using a language model to ensure that the overall sentence structure and meaning are intact.

At step 326, the question classification process classification service (Q/C, Q->Metadata) component 140 may classify the corrected and categorized question into one of several predefined categories based on the type of information being asked (e.g., “Who”, “What”, “Where”, “Why”, etc.). The question classification process may help define the structure of question sentences by performing feature extraction to extract relevant features from the question, such as who, when, where, and how. This step may help to route the question to the appropriate answer retrieval system or knowledge base.

At step 326, during the question classification process, the classification service (Q/C, Q->Metadata) component 140 may use feature extraction techniques, such as “keywords” or question words, “part-of-speech (POS) tagging,” “word embeddings,” and “n-grams.” All these techniques may be used in NLP to identify key semantic elements within a text, allowing for better understanding and analysis of the content when performing tasks such as question answering or sentiment analysis.

In an exemplary embodiment that implements the question classification process at step 326, the keywords or question words technique (e.g., who, what, where) may be used to identify specific words within a text that directly indicate the core information being asked in a question, such as “who” for person identification, “what” for describing an event, or “where” for location details.

In another exemplary embodiment implementing the question classification process at step 326, the POS tagging technique (e.g., nouns for “Who,” locations for “Where”) may be used to assign grammatical labels to each word in a sentence, such as “noun,” “verb,” “adjective,” etc. This technique may help to identify the role of each word in the sentence, which is important for extracting important features.

In a further exemplary embodiment that performs the question classification process at step 326, the word embeddings method (e.g., BERT embeddings) may use the vector database component 146 to represent words as vectors in a high-dimensional space, where words with similar meanings are located close to each other. This allows for capturing semantic relationships between words beyond their literal meaning.

In an exemplary embodiment that performs the question classification process at step 326 by analyzing n-grams, the classification service (Q/C, Q->Metadata) component 140 may capture word combinations and phrases that may hold important meaning, even if the individual words themselves are not particularly informative. The N-grams (e.g., bi-grams or tri-gams) are sequences of N words that appear together in a text.

In addition, at step 326, the question classification process may include using a classification model to determine the question type. During the question classification process, the classification service (Q/C, Q->Metadata) component 140 may use one or more common approaches of classification modeling, such as traditional machine learning classifiers (e.g., Logistic Regression, SVM) trained on labeled question data and deep learning models (e.g., LSTM, Bidirectional Long Short-Term Memory (BiLS™), or BERT-based models for question classification.

At step 326, the question classification process may output a label indicating the type of the question (e.g., “What is,” “Who is,” “How to,” etc.).

After the first stage-layout extract/parse at step 212, as described in FIG. 3A, the question classification document may be transferred to the second stage AI answer generation at step 214 in FIG. 3B for further processing by the RFP GenAI engine (i.e., the AI pillar) 106. At step 214, the second stage AI answer generation leverages generative AI models to create personalized and contextually appropriate RFP responses to the questions posed in the RFP document 158. The second stage AI generation ensures that the generated content is not only accurate but also tailored to the specific needs and preferences of the client.

After the AI of the classification service (Q/C, Q->Metadata) component 140 has generated the question classification document at step 326 in FIG. 3A, the process of the second stage of AI answer generation at step 214 may involve a “human-in-the-loop” step at 328 where the AI generates an initial question classification document by the classification service (Q/C, Q->Metadata) component 140, and humans then review and refine them as needed.

At step 330, human annotators may evaluate the AI's output of the question classification document to ensure it meets specific criteria for quality. By combining AI with human judgment at step 330, the quality of the generated question classification may be significantly enhanced to generate AI answers in step 332. By reviewing and adjusting the AI-generated question classification, humans may use the comments component 116 to provide feedback to improve the model's performance over time.

In FIG. 3B, at step 332, the process may generate the AI answers using the answer generation component 142. In embodiments, the AI answer generation component 142 may be configured as software that uses AI to provide human-like responses to questions or prompts. The AI answer generation component 142 may generate the AI answers by analyzing the input text, understanding the context, and meaning, and then generating a relevant response.

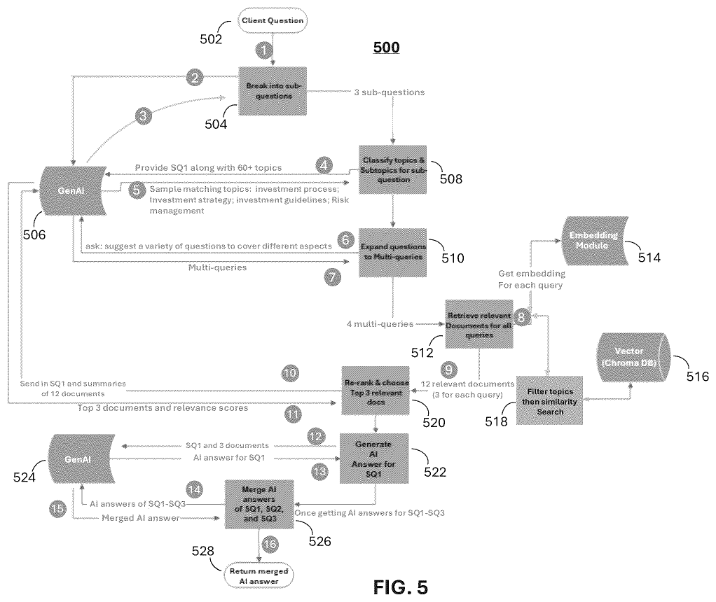

At step 332, the AI answer generation process may be configured as a dynamic and multi-stage cycle that combines information retrieval, ranking, personalization, evaluation, and feedback. Each stage builds on the previous one to ensure that the AI delivers accurate, relevant, and context-aware responses that align with both user needs and client-specific rules. Continuous integration of user feedback may help to refine the system 100, improving its performance over time. The AI answer generation processing step 332 is illustrated in further detail in FIG. 5, which is a flowchart illustrating steps in performing an AI answer generation processing method 500.

At step 334, a standard document RAG process may be performed by the AI answer generation component 142. In step 334, the AI answer generation component 142 may use RAG to fetch relevant information from a large corpus of documents or knowledge bases. The RAG may combine two major processes that include document retrieval and answer generation. During the document retrieval process, the AI answer generation component 142 may search and retrieve documents, articles, or datasets that are most likely to contain the answer to the RFP's questions. After the relevant documents are identified, the answer generation process may use AI to synthesize the information to formulate a coherent response. This step improves the quality of the AI-generated answer by relying on reliable sources, such as a Golden Source.

After the relevant documents are retrieved, then at step 336, a standard document reranking process may be performed by the AI answer generation component 142. This process may involve ranking the retrieved documents in order of relevance based on various factors such as: content match, document quality, and context relevance. The content match process may determine how closely the document matches the RFP's query. The document quality process may evaluate the trustworthiness and authority of the source. The context relevance process may determine the relevance of the document to the current RFP query or context. The reranking process helps to prioritize the most informative and accurate sources, ensuring that the AI uses the most pertinent documents when generating the answer.

At step 338, a client rule integration process may be performed by the AI answer generation component 142. The generated answer may be subjected to the client rule integration process, where specific rules or guidelines set by the client are applied to ensure the response aligns with the business or user needs. These rules may include tone and style, domain-specific terminology, and compliance. The tone and style rules may ensure that the response matches the company's tone (e.g., formal, conversational, friendly). The domain-specific terminology rules may address specific industry terminology, language, or jargon that the client prefers. The compliance rules may comply with legal, privacy, security, or regulatory requirements, such as the Health Insurance Portability and Accountability Act (HIPAA). The client rule integration process may ensure that the AI's responses are not only accurate but also aligned with the client's goal and business requirements.

At step 340, a personalization process may use the personalization component 136 to personalize the AI answer to suit the individual user's context. The personalization process may include user profiling, context awareness, and behavioral insights. During the user profiling process, the AI may use past interactions, preferences, and demographic data (if available) to tailor the answer to the user's particular needs. For example, if a user typically prefers concise responses, the AI may provide shorter, to-the-point answers. In the context awareness process, the AI may consider the context of the current RFP query, including previous questions, ongoing projects, or specific challenges the user may be facing, to provide more relevant and timely responses. The behavioral insights process may use the AI to personalize responses based on how the user interacts with the system 100 (e.g., the type of information they seek or the way they phrase queries).

At step 342, an AI answer evaluation process may be performed by the writers. After the personalized response is generated at step 340, the AI answer generation component 142 may evaluate the quality and accuracy of the AI-generated answer in step 342. This evaluation may employ several mechanisms, for example, internal consistency, factual accuracy, and relevance.

The internal consistency mechanism may use the AI to check the coherence and clarity of the answer. This mechanism may check to ensure that the response is clear, logically structured, and easy to understand. The factual accuracy mechanism may function as a validation mechanism employed to cross-check information against trusted sources or databases. This mechanism may cross-reference the answer with trusted sources to ensure factual correctness.

The relevance mechanism may assess how well the answer addresses the specific needs of the RFP's query. In some embodiments, the AI may assign a confidence score or perform internal checks to validate the answer before presenting it to the user. The generated answers may be automatically rated or scored against a set of criteria (e.g., informativeness, relevance). If necessary, the AI may adjust its response for greater accuracy or clarity before presenting it to the user.

At step 344, a user feedback integration process may be performed by the comment component 116, which enables the user to provide feedback and annotations on the RFP documents. During the user feedback integration process, the system 100 may collect and analyze feedback from users regarding the quality of the generated response. This process may include explicit feedback, implicit feedback, and sentiment analysis. Through explicit feedback, users may rate the answer and provide direct ratings, such as thumbs up/down, comments, or suggestions. Using implicit feedback, the system 100 may analyze user behavior, such as whether they asked a follow-up question, rephrased the query, or spent additional time reading the response.

This behavioral data, such as whether the user followed up with additional questions, may indicate the completeness of the answer. This feedback may then be used to fine-tune the AI model for future interactions, helping to improve the response quality, address gaps, and adapt to changing user preferences over time. Through the implementation of sentiment analysis, the AI may also analyze the tone and sentiment of the user feedback to determine satisfaction. This feedback may be used to fine-tune the AI model, improve its future responses, and adapt to changing user preferences and needs.

In FIG. 3C, at step 216, the third stage AI answer curation and finalization may involve reviewing and refining the generated RFP responses. This stage uses the AI answer curation and finalization component 143 to ensure that all responses undergo necessary checks and receive the required endorsements before finalization. The third stage, AI answer curation and finalization, may include AI answer curation at step 346 and final document generation at step 352.

At step 346, the AI answer curation process may use the answer curation and finalization component 143 to transform the AI answers from raw, automated responses into high-quality, reliable responses that meet the needs of the user, making the information more accurate, understandable, well-organized, and contextually appropriate.

At step 346, the AI answer curation process may include a systematic process configured to ensure that the AI-generated responses meet high standards of quality, accuracy, and clarity. This process may include multiple stages, such as AI answer review/edit, and curated answer review/revision.

At step 348, an AI answer review/edit process may be performed using the AI answer curation and finalization component 143. In this stage, AI-generated answers may be thoroughly reviewed to assess their accuracy, coherence, and relevance to the question. One of the goals of this process may be to ensure that the content is factual, logically structured, and free of grammatical errors. Any inconsistencies or unclear phrasing may be corrected, and the content may be refined to improve readability. Reviewers may also identify and correct any biases or irrelevant information, ensuring that the answer meets the required quality standards.

At step 350, a curated answer review/revision process may be performed using the AI answer curation and finalization component 143. After the AI-generated answers have been edited, further review and refinement may be applied to the answers. The curated answer review/revision process may be used to adjust the content to better suit the intended audience or platform. The answer may be revised to ensure that it is not only accurate but also aligned with the specific tone, style, and level of detail needed. This step may include rewording or reorganizing parts of the response to enhance clarity, relevance, and comprehensiveness.

At step 352, the final document generation process, which may include AI answer consolidation and formatting/finalizing, may be performed using the answer curation and finalization component 143. After the answers have been carefully reviewed and revised, the process moves to the final document generation phase. In this step, the answers may be consolidated into a cohesive, structured document. The content may be organized logically, with proper transitions between sections to create a seamless flow of information. This may include integrating multiple answers or perspectives into a single, unified response if necessary.

At step 354, the AI answers may be consolidated into a polished, professional document that adheres to the required format for the RFP response document 164 or another type of deliverable.

At step 356, formatting and finalizing the document may be performed. This step may include applying consistent styling, ensuring proper citation of sources if needed, and checking for any remaining grammatical or typographical errors. The RFP response document 164 may then be finalized to ensure it is ready for publication or delivery.

After the RFP response document 164 has been formatted and finalized at step 356 in the third stage AI answer curation and finalization 216, the RFP response document 164 as an intermediary document may be transferred to the Post-Auto RFP phase 218.

Returning to FIG. 2, the Post-Auto RFP phase 218, within the high-level end-to-end method 200, manages the final stages of the RFP process, including downstream review and operations at step 220. At step 220, the downstream review/operation component 168 may conduct the downstream review/operation to ensure that all generated responses are reviewed and approved before being sent out of the system 100. During the Post-Auto RFP phase 218, the downstream review/operation component 168 may interact with various other components to ensure a comprehensive and efficient approach to managing the RFP process.

At step 220, during the downstream review and operations, the downstream review/operations component 168 may perform the final review and approval of the RFP responses. The downstream review/operations component 168 may ensure that all responses meet the necessary criteria and standards before being finalized. The downstream review/operations component 218 may collaborate with the audit component 122 to maintain a detailed log of all actions taken, supporting compliance and quality control.

After the completion of the downstream review and operations at step 220, the system 100 outputs a composed RFP response document 164.

In one example, data used in the high-level flow 200 in FIG. 2 and the low-level flow 212, 214, and 216 in FIGS. 3A-3C may be obtained from the original vetted data in ICM component 160 which may be the Golden Source used, for example, by an OCIO. As an initial consideration, training data used for the SmartRFP tool 166 may include a golden set of sources to ensure its suitability and representativeness. The current methodology may use the Golden Source of data for RAG indicators.

In one embodiment, a golden set of sources may be used to ensure suitability, sourcing, completeness, representativeness, and accuracy of both the training and runtime data for SmartRFP tool 166. The current methodology may rely on authoritative repositories, such as the Golden Source for RAG indicators.

Other embodiments, however, may restructure the content database to improve its structure and metadata, implement a feedback loop to continuously improve the content, and enable historical content ingestion and consumption for better context. These other embodiments may also expand prototypes for image and rich content and incorporate other sources, such as investment GPT™ for a wider range of content and more precise answers while reducing manual effort.

By way of example only, and not limitation, the data set used to train the SmartRFP tool 166 may include a golden set of sources that have been carefully selected for their suitability and representativeness. The chosen data set may be suitable for the tool and its purpose due to several reasons. The golden set of sources may ensure high-quality data, providing reliable information for training the tool. This may help in achieving accurate predictions and recommendations. Also, the selected data set may be relevant to the tool's purpose, focusing specifically on RFP assistance. This may ensure that the tool is trained on data that aligns with the specific needs and requirements of users in the RFP domain.

The data set may encompass a diverse range of content, covering various industries, sectors, and scenarios related to RFPs. This diversity may allow the tool to learn patterns, understand context, and provide comprehensive assistance across different contexts. Additionally, the data set may be carefully curated to represent a wide range of RFP scenarios and potential user queries. This may ensure that the tool is trained on a comprehensive set of data, enabling it to handle a broad spectrum of user inquiries effectively.

A desirable data set for training the SmartRFP tool 166 may be suitable as it embodies quality, relevance, diversity, and representativeness, all of which are essential for creating an effective and robust tool that may provide accurate and helpful assistance in the RFP domain.

The SmartRFP tool 166 may utilize historical RFPs from different types of organizations for testing the content and comparing it against the user base. This approach may help in evaluating the effectiveness and accuracy of the tool's responses and recommendations. By leveraging historical RFPs, the tool may gain valuable insights into the real-world scenarios that users may encounter. These RFPs may be obtained from a diverse range of organization types such as government agencies, non-profit organizations, and private businesses. This may ensure that the tool's content is tested against a variety of contexts, requirements, and industry-specific nuances.

Testing the content with historical RFPs also may allow for an assessment of how well the SmartRFP tool 166 understands and interprets different RFP formats, keywords, and complexities. It may also enable the tool to provide informed recommendations based on past successful strategies and best practices. Furthermore, comparing the performance of the tool's content against the user base may help to identify areas of improvement and potential gaps in the knowledge base.

The comparisons may allow for continuous refinement and enhancement of the tool's responses to better meet the evolving needs and preferences of users. By incorporating historical RFPs from various organization types and evaluating the content against user feedback, the SmartRFP tool 166 may ensure that it provides comprehensive and reliable assistance to users across different industries and organizational contexts.

In embodiments, the ICM component 160 may be used as an upstream tool in one or more exemplary embodiments. As known to those of skill in the art, generally, an ICM is an upstream tool that serves as a standard tool for managing and controlling content within an asset, wealth, management (AWM) organization. It acts as a centralized platform where content is created, stored, organized, and updated. Stating that the ICM component functions as an upstream tool means that it operates at an earlier stage in the content workflow, focusing on the creation and management of content before it is disseminated to downstream systems or applications. It plays a crucial role in ensuring the quality, consistency, and accuracy of content before it is utilized elsewhere.

As a standard tool that adheres to established specifications and measurements and produces consistent results, the ICM component 160 may set a benchmark for content management practices within the organization. It may provide standardized templates, guidelines, and workflows that facilitate the creation and maintenance of content in a consistent manner. This consistency may help in building a coherent and unified content ecosystem across different teams, departments, or business units. The ICM component 160 may also allow authorized users to create and edit content within a controlled environment. It may offer features such as version control, access permissions, and collaboration tools that promote efficient content creation and collaboration among team members.

Furthermore, the ICM component 160 may enable content governance by establishing rules, policies, and workflows for content review, approval, and publication. This may ensure that content undergoes appropriate checks and balances before being published or shared. By using the ICM component 160 as an upstream tool and a standard tool, organizations may streamline their content management processes, maintain content quality and consistency, enhance collaboration, and enforce content governance. This may ultimately lead to improved content accuracy, efficiency, and overall content management effectiveness.

Typically, the use of conventional AI systems may pose certain risks, for example, misplaced trust, unwanted bias, over-estimating the AI's capabilities, and over-reliance on certain forms of explanations. To mitigate these risks, the present disclosure may provide guardrails and citations pointing back to the Golden Sources that are utilized, along with clear explanations of how answers are derived. To ensure explainability, the SmartRFP tool 166 may implement guardrails that provide transparency into the decision-making process of the AI/ML models.

This may be performed using techniques such as model interpretability, feature importance analysis, or generating explanation text that accompanies the AI-driven predictions. Additionally, citations pointing back to the Golden Source may be provided. By referencing the specific sources of information used in deriving the answers, users may trust the results and have confidence and understanding of the underlying data and methods.

To address bias and fairness concerns, the SmartRFP tool 166 may proactively assess and identify potential areas where biased outcomes may occur. This may involve performing rigorous testing and validation against representative and diverse datasets. By testing with different subsets of data, biases may be detected, measured, and addressed. Addressing identified biases or fairness concerns may involve incorporating fairness metrics and reweighting datasets. Implementing guardrails, providing citations to the Golden Source, and describing the steps taken to mitigate bias and fairness concerns, results in greater transparency, accountability, and trust in AI/ML analytical tools. This may help the users better understand the logic behind the tool's decisions while reducing the risk of biased outcomes.

FIG. 5 illustrates a flow diagram of an exemplary method 500 of performing AI answer generation in response to a client question (CQ), in accordance with the embodiments. In an embodiment, method 500 may employ the answer generation component 142 to implement the AI answer generation in response to the CQ, in accordance with the embodiments.

The method 500 begins with step 502 where a CQ may be received along an example path, such as path (1), which serves as the input for subsequent processing stages. As an example, a CQ may be a request to: “CQ: Describe your process for review/development of investment policy, spending policies, objectives, and guidelines.”

The CQ may be analyzed via GenAI module 506, along example path (2), and decomposed and broken into SQs. In embodiments, the SQs may be rephrased in various ways. By way of example, the GenAI module 506, may be implemented as Google® Gemini™, Microsoft® Copilot™, GPT-4®, or similar GenAI applications. That is, step 504 may involve identifying distinct components within the CQ that require individual responses. By way of example, the CQ may be broken into SQs SQ1-SQ3 and rephrased as follows:
SQ1: Describe your process for review/development of investment policy.
SQ2: Describe your process for review/development of spending policies.
SQ3: Describe your process for review/development of objectives and guidelines.

The corresponding SQ1-SQ3 are returned along path (3) to step 504. The method 500 then proceeds to step 508, where SQ1-SQ3 are forwarded and classified as topics and subtopics. For example, SQ1 may be provided along path (4), for example, with more than 60 topics (i.e., relevant pages) from a document or database (not shown) to the GenAI module 506. Matching topics for SQ1-SQ3 may be returned by the GenAI module 506 to step 508 along path (5).

In step 510, the GenAI module 506 may expand SQ1-SQ3 into multiple queries to ensure comprehensive coverage of different aspects. In one example of the multiple queries, the GenAI module 506 may be asked, via path (6): “Suggest a variety of questions to cover different aspects of SQ1-SQ3.” In response, the GenAI module 506 may expand SQ1-SQ3 into multiple queries. An example of four multiple queries regarding SQ1 may include:
What is the timeline for the investment policy review and development process?
How do you incorporate client risk tolerance and objectives into the investment policy?
What tools and resources do you use to analyze and develop investment policies?
How do you ensure compliance with regulatory requirements during the investment policy review process?

By way of example only, and not limitation, the multiple queries may be returned to step 510 along path (7). The method 500 then proceeds to step 512. The four example multiple queries may be provided as an input to step 512. In step 512, the method 500 retrieves relevant documents for all queries. As an initial action in the relevant documents retrieval process, embedding for each query may be obtained from embedding module 514.

The embedding module 514 processes the queries and potential answers. To create vector representations for performing similarity searches. The embedding information may be returned along path (8) to step 512.

In a subsequent action in the relevant documents retrieval process, vector database 516 may use the vector representations created by the embedding module 514 to perform the search for relevant documents. Using the vector database 516 helps to ensure responses are accurate and contextually relevant. In step 518, pages may be filtered based on similarity scores to identify the most relevant documents in completing the retrieval of relevant documents performed in step 512.

In step 520, method 500 may re-rank and choose the top 3 relevant documents retrieved in step 512 and forwarded to step 520 along path (9). By way of example only, step 512 may forward 12 documents to step 520 (i.e., 3 for each multiple query). The first sub-question (SQ1) and summaries of the 12 documents may be provided to the GenAI module 506 along path (10) for analysis and scoring. In one example, the top 3 documents may be identified by the GenAI module 506, along with their relevance scores, to ensure the best possible answers are selected. The 3 identified documents may be provided to step 520 via path (11) for further processing to generate comprehensive answers.

In step 522, AI answers for SQ1 may be generated via GenAI module 524 along path (12). The GenAI module 524 may process the selected documents to generate AI answers for each of SQ1, SQ2, and SQ3. In the method 500 of FIG. 5, AI answers for SQ1 may be returned along path (13) to step 522.

The method 500 proceeds to step 526. AI answers for SQ1-SQ3 may be forwarded to the GenAI module 524, where all answers for SQ1-SQ3 are compiled. This compiling process ensures they are coherent and contextually appropriate. More specifically, the GenAI module 524 may merge the answers for the first SQ1 to form a comprehensive response and may be returned to step 526 via path (15). The merged answer for SQ1 may be returned to the client in step 528 along path (16), providing a complete and contextually relevant response.

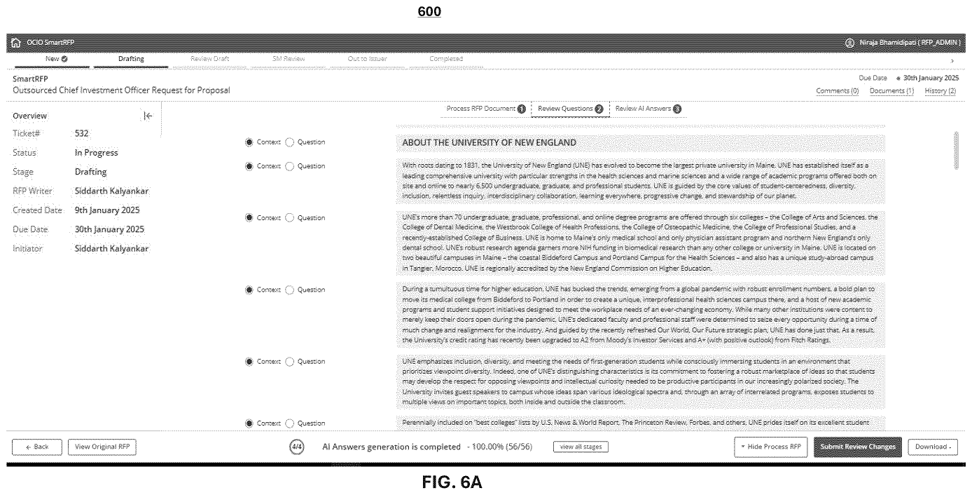

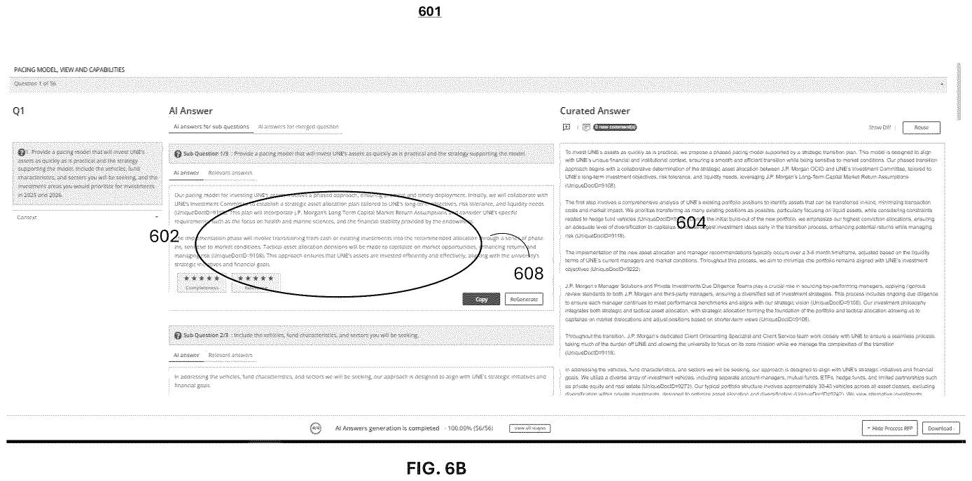

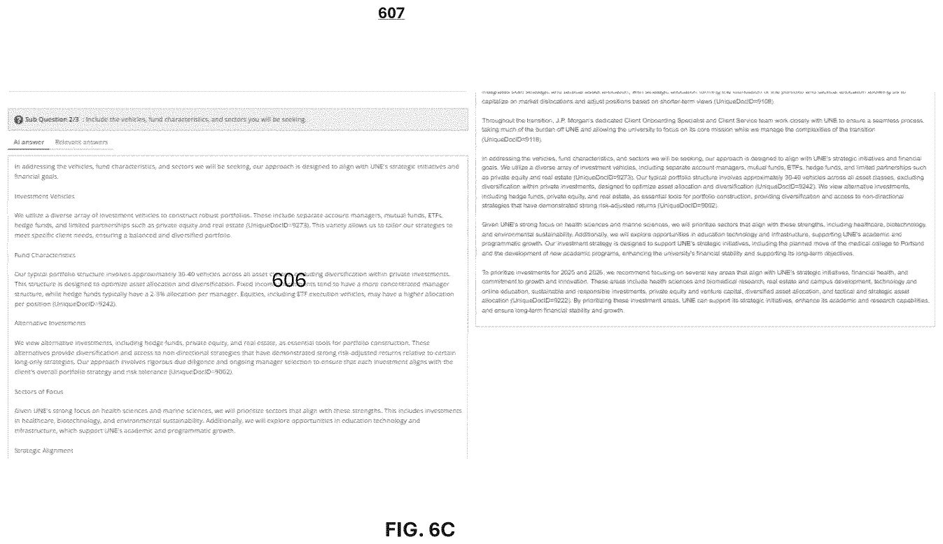

Throughout the multiple stages of the process in FIGS. 2 and 3A-3C carried out by the system 100, intermediary and final smart RFP outputs may be generated as shown in FIGS. 6A-9. In certain example implementations, the smart RFP outputs generated may include, for example, (i) parsed RFP documents with identified questions and context, (ii) an annotated RFP response document with AI recommendations, (iii) generated answers based on the GenAI engine's analysis and retrieval from a standard database, (iv) a final curated answer with user collaboration and comments, (v) simplified final content for review, and approval/disapproval and (vi) a final RFP response document generated in an original layout.

FIG. 6A illustrates a screenshot 600 of an exemplary UI for processing a response to an RFP. AI allows the UI to be used to categorize and extract content into context and question sections. In FIG. 6A, the UI may allow the user to annotate and review the document. The UI of FIG. 6A shows a list of contexts and questions extracted from the RFP, providing options for the user to specify any mislabeled content or misclassifications. In FIG. 6A, the document is shown in the drafting stage, with details information, such as dates and the responsible person visible. The UI 600 may include buttons for processing steps, reviewing changes, and submitting the document for further stages.

FIG. 6B illustrates a screenshot 601 of a UI for processing RFP responses. In particular, the screenshot 601 shows questions 802 from the RFP, labeled as “Question 1 of 69,” with AI-generated answers. The RFP GenAI engine 106 may be configured to answer each of the relevant questions. The RFP GenAI engine 106 may categorize the content into SQs 604 and provide AI-generated answers 606 as shown in the UI in FIG. 6A.

The UI may allow the user to review and curate answers, indicating if a question is unanswerable. The user may interact with the interface to refine responses, ensuring accuracy and relevance. The layout, illustrated in the screenshot 601, may include navigation options for processing and reviewing changes.

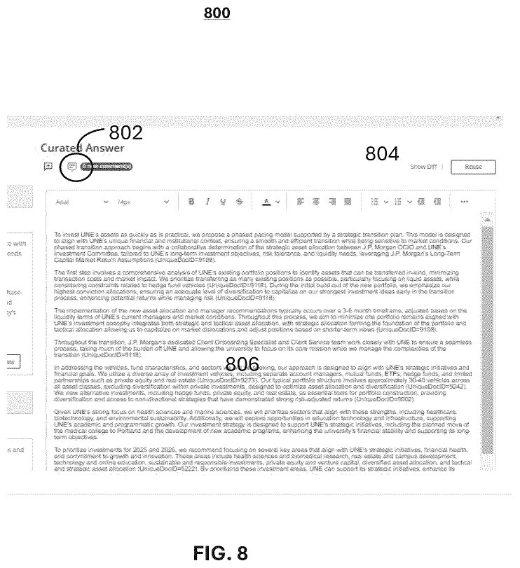

In FIG. 6B, one objective is to break down larger questions, such as question 602, into smaller questions (e.g., question 604). By way of example, each of the smaller questions may be answered using an underlying pipeline 606 (see screenshot 607 in FIG. 6C). The underlying pipeline 606 may be used to prepare AI answers 608, illustrated in FIG. 8B. In some instances, if one of the AI answers 608 is considered suboptimal or deficient, that question may be labeled as “unanswerable,” or partially completed. Labeling a question as unanswerable or partially completed is a type of guardrail alerting and providing the user with an opportunity to activate additional features of the smart RFP system 100. One feature may provide the user with access to additional external information that may help revise or enhance the answer.

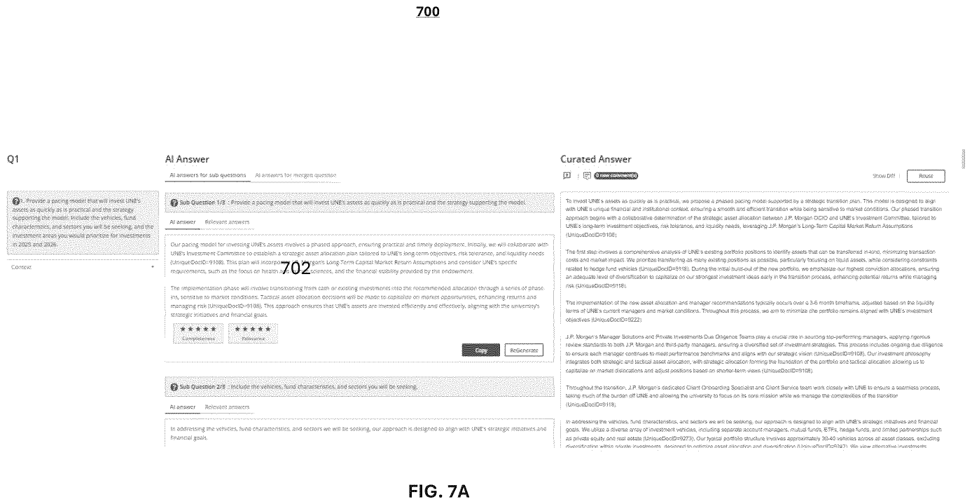

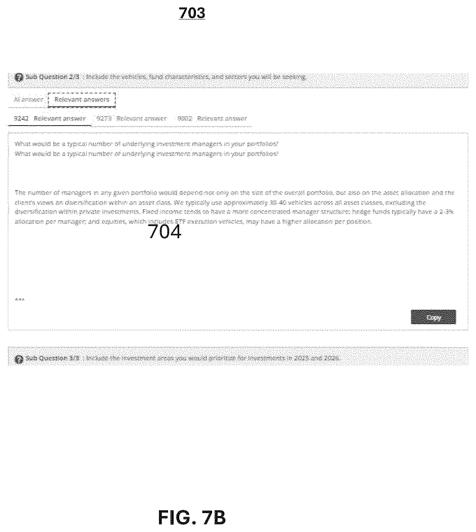

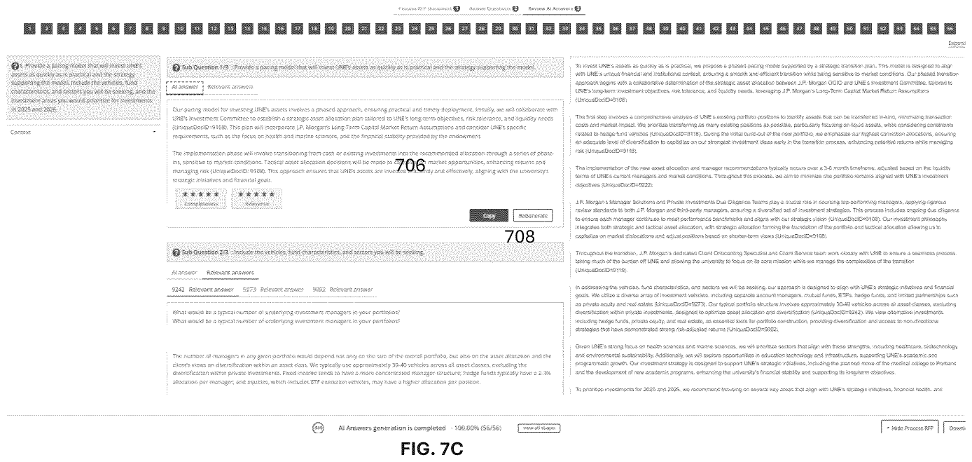

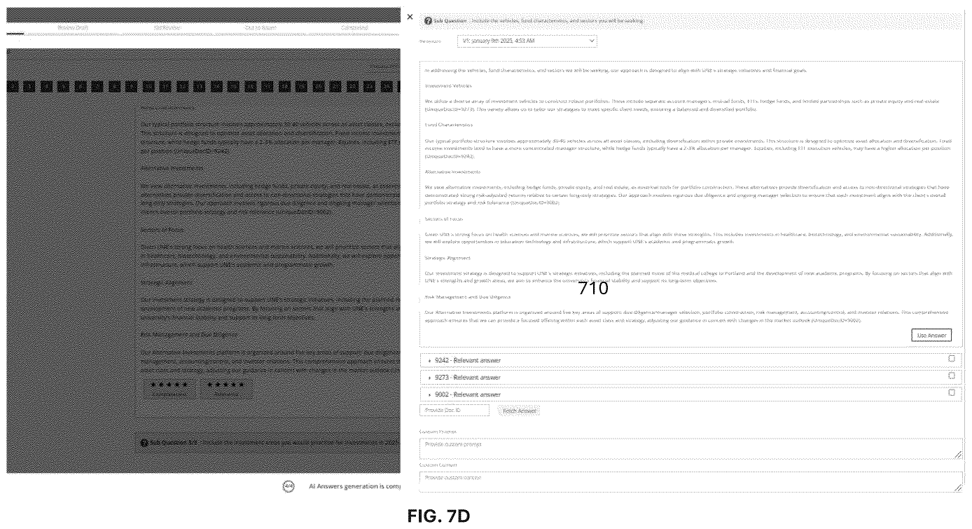

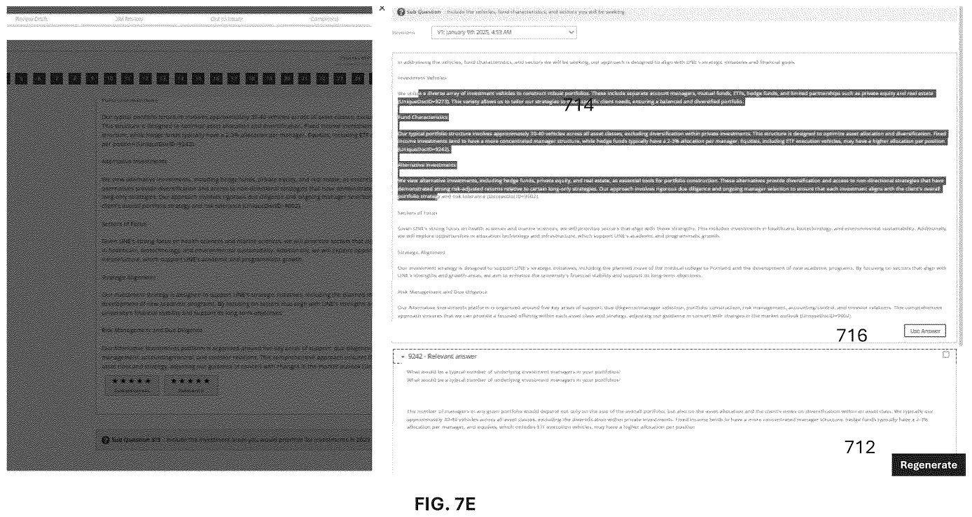

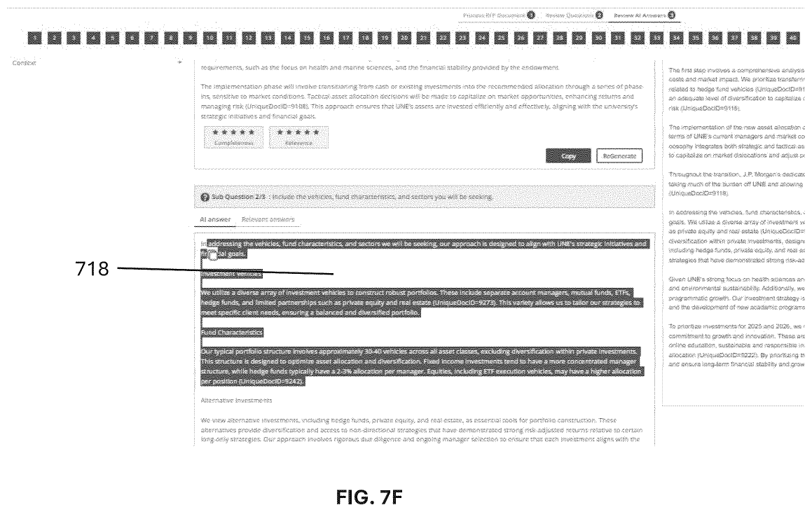

FIGS. 7A-7F illustrate various screenshots depicting example uses of AI-generated answers in accordance with the embodiments. In FIG. 7A, screenshot 700 depicts exemplary AI generated answers 702 upon which the users may perform different operations. For example, screenshot 703 of FIG. 7B shows the user which AI-generated answers 704 are the most regarded, most relevant, and/or the highest quality of the AI answers 702.

In FIG. 7C, if the user is not satisfied with AI answers 706, a capability 908 is provided to regenerate some of the answers of the AI answers 706. A regenerate button 708 enables the user to regenerate AI answers. For example, the user may “cherry-pick” some of the answers here, 10, as depicted in FIG. 7D. As depicted more clearly in FIG. 7E, a regenerate button 712 enables the user to produce and display regenerated AI answers 714. For example, the user may click a “use answer” button 716 and the AI answer will be displayed in corresponding fields here 718, depicted in FIG. 7F.

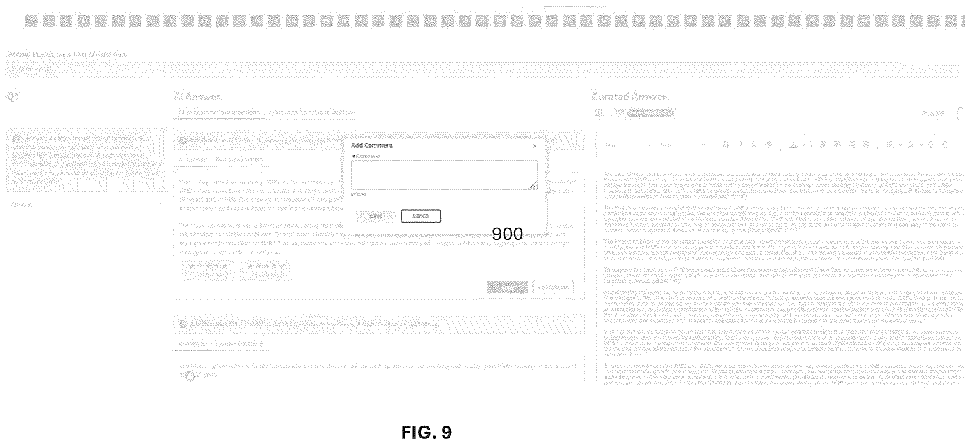

FIG. 8 illustrates a screenshot 800 with curated answers 802. For example, the user may enter text at UI 804 and then collaborate with other users by adding comments 806. Responsive to the comments 806, one or more of the collaborative users may perform various actions via GUI 900, illustrated in FIG. 9. In this manner, multiple users may simultaneously create and collaborate on community answers.

Various embodiments of the system and method described and shown in the present disclosure may be implemented using AI smart technology. This AI smart technology employs various applications of AI to enhance human capabilities by automating tasks that traditionally require human intelligence. Various embodiments of the present disclosure may include AI smart technologies, such as ML, deep learning, NLP, and computer vision.

The use of ML may enable system 100 to learn from data and improve its performance over time without explicit programming. In an embodiment, the system 100 may apply deep learning, which is a subset of ML that utilizes artificial neural networks to process complex information. The use of NLP may allow system 100 to understand and interpret human language. By way of example, computer vision may enable system 100 to interpret and understand visual information.

For example, FIG. 10A illustrates an AI smart integrated process 1000A of a smart workflow component 1002, a smart writer component 1004, and a smart content component 1006. At a high level, the integrated process 1000 may receive all the RFP information and may help with audit management. The integrated process 1000 may also help manage who the writer is, who is doing what, who can upload and read the entire RFP, and who understands the questions. All questions in the questionnaire are understood, processed, and matched to the best answers, which are stored in a content repository. The integrated process 1000A may compile all the information together, answer the questions, and as a result, the RFP responses are generated.

The embodiments may be configured to evaluate whether the context of the answers is relevant versus the question asked, based on metrics. The embodiments may include guardrails that help prevent hallucinations. To prevent hallucinations, this may be achieved through the strategic integration of pre-trained language models with fine-tuned prompts augmented with additional training on structured, domain-specific datasets to closely reflect the intricacies of RFP documents.

Namely, the system 100 may include a hallucination prevention module (not shown) for preventing hallucinations and ensuring fairness in the RFP response document by providing references to the authoritative sources used. The hallucination prevention module may be configured to prevent hallucinations by performing strategic integration of pre-trained language models with fine-tuned prompts augmented with training on structured, domain-specific datasets to critically analyze the RFP document by closely examining the construction, content, and language closely to form a clear interpretation of the document.

The system may incorporate a rigorous set of computational guardrails designed to ensure that all queries and inputs adhere to predefined validation criteria. Further embodiments may include a verification layer, where outputs generated by the AI are cross-referenced against the original documents to validate their accuracy and relevance. The present disclosure may also prescribe a human oversight mechanism, where outputs of significant consequence are manually reviewed to ensure reliability.

In embodiments, continuous updates to the methodology based on new data and feedback may form a feedback loop that is integral to the system 100, facilitating ongoing improvement and adaptation to evolving industry standards and document formats. The innovative approach of the present disclosure ensures enhanced accuracy, reliability, and industry compliance in smart RFP systems. The users may be presented with citations for extra explainability that allows the users to comprehend and trust the results and output created by the machine learning algorithms. In embodiments, the user may also be presented with a variety of options such as selecting relevant answers, regenerating the answer with additional inputs, or fine-tuning the AI-generated answer with Gen AI (or manually).

Specifically, in FIG. 10A, the smart workflow component 1002, integrates various stages of the RFP process, ensuring a seamless transition from document input to final response generation. This component may coordinate the flow of information and tasks, enabling efficient management of the RFP lifecycle. The smart workflow component 1002 may interact with other components, such as context inputs and content collaboration, to ensure that necessary data and stakeholder inputs are incorporated into the workflow.

A context inputs component 1008 may serve as the foundational data source for the AI system, providing background information and parameters that guide the RFP response generation. This ensures that the AI engine has access to relevant context, which is important for accurate question identification and response formulation. The context inputs component 1008 may interface with the GenAI engine to deliver context-specific data that enhances the precision of the generated responses.

A content collaboration component 1010 may facilitate the interaction between multiple stakeholders involved in the RFP process. This component may support simultaneous input and feedback from various users, ensuring the RFP response reflects a comprehensive and collaborative effort. The content collaboration component 1010 may integrate with a user dashboard to provide a centralized platform for document sharing and discussion, enhancing communication and coordination among team members.

An approvals and notifications component 1012 may manage the review and approval stages of the RFP process. This component ensures that all generated responses undergo necessary checks and receive the required endorsements before finalization. The approvals and notifications may work in conjunction with an audit management component 1014 to track changes and approvals, maintaining a record of all modifications and decisions made during the RFP process.

The audit management component 1014 may provide a systematic approach to tracking and documenting all activities and changes within the RFP process. This ensures transparency and accountability by maintaining a detailed log of all actions taken, including content modifications and approvals. The audit management component 1014 may support compliance and quality control by enabling easy access to historical data and decision records.

A user dashboard component 1016 may offer a user-friendly interface for managing the RFP process. This tool may provide the user with access to all necessary tools and information, including workflow status, document versions, and collaboration features. The user dashboard component 1016 may integrate with a workflow and process automation component 1018 to streamline user interactions and enhance the overall efficiency of the RFP process.

The workflow and process automation component 1018 may automate repetitive tasks and processes within the RFP lifecycle, reducing manual effort and minimizing errors. This component leverages AI/ML to optimize the flow of information and tasks, ensuring that the RFP process is both efficient and effective. Additionally, this component may interact with a management reporting component 20 to provide real-time insights into process performance and outcomes.

The management reporting component 1020 may deliver analytical insights and performance metrics related to the RFP process. This component may provide stakeholders with data on workflow efficiency, response quality, and overall process effectiveness. Management reporting supports data-driven decision-making by offering detailed reports and visualizations that highlight performance indicators and trends.

In FIG. 10A, the smart writer component 1004 may be responsible for generating the initial draft of the RFP response. This component may utilize advanced AI algorithms to produce coherent and contextually relevant answers to the identified questions. The smart writer component 1004 may collaborate with a questionnaire extraction and content analysis component 1022 may ensure that all responses align with the extracted questions and context.

The questionnaire extraction and content analysis component 1022 may identify and categorize questions and context within an uploaded RFP document 158. This component may employ NLP techniques to accurately extract relevant information. The relevant information may then be used by the smart writer component 1004 to generate appropriate responses. The questionnaire extraction and content analysis component 1022 may play a role in ensuring that the GenAI engine 106 understands the document's structure and content.

An advanced semantic search component 1024 may enhance the ability of the GenAI engine 106 to retrieve precise answers from the content repository. This component may employ sophisticated search algorithms to locate the most relevant information based on the extracted questions and context. In embodiments, the advanced semantic search component 1024 may be custom-built to improve the relevance and correctness of the RFP. The advanced semantic search component 1024 may also help to ensure that incomplete and verbose data is still accommodated within the system 100. The advanced semantic search component 1024 may support the smart writer component 1004 by providing high-quality data that informs the response generation process.

A content generation component 1026 may use GenAI models to create personalized and contextually appropriate RFP responses. This component may ensure that the generated content is not only accurate but also tailored to the specific needs and preferences of the client. The content generation component 1026 may integrate with a personalization of content component 1028 to deliver customized responses that enhance the overall quality and relevance of the RFP.

The personalization of content component 1026 may tailor the RFP responses to meet the requirements and expectations of the client. This component may utilize client-specific data and preferences to adjust the tone, style, and content of the responses. The personalization of content component 1026 may work closely with the content generation component 1026 may use GenAI components to ensure that responses are highly personalized and client-centric.

A multi-document (Doc) generation component 1030 may support the creation of multiple RFP documents simultaneously, enabling efficient handling of large volumes of requests. This component may automate the generation of various document formats and versions, ensuring consistency and accuracy across all outputs. The multi-Doc generation component 1030 may interact with the smart content component 1006 to maintain high standards of content quality and coherence.

In FIG. 10A, the smart content component 1006 may ensure the quality and consistency of the generated RFP responses. This component may employ a systematic content quality benchmarks component 1032 to evaluate and refine the responses, ensuring that they meet predefined standards. The smart content component 1006 may collaborate with a restructured content database component 1034 to continuously improve a content repository and enhance the overall quality of the RFP outputs.

The systematic content quality benchmarks component 1032 may provide a framework for assessing the quality and effectiveness of generated RFP responses. This component may establish criteria and metrics for evaluating content, ensuring that all responses are accurate, relevant, and coherent. The systematic content quality benchmarks component 1032 may support the smart content component 1006 in maintaining high standards of quality and consistency.

A restructured content database component 1034 may involve the organization and optimization of the content repository to improve data retrieval and response generation. This component may ensure that the content database is well-structured and up-to-date, facilitating efficient access to high-quality information. The restructured content database component 1034 may work with a feedback loop component 1036 to incorporate user feedback and continuously enhance the content repository.

The feedback loop component 1036 may enable continuous improvement of the RFP process by incorporating user feedback and insights. This component may collect and analyze feedback from users, identifying areas for enhancement and refinement. The feedback loop component 1036 may collaborate with the restructured content database component 1034 to implement changes and updates that improve the overall quality and effectiveness of the RFP responses.

A historical content ingestion and consumption component 1038 may allow the system 100 to leverage past RFP and RFP response data and insights to inform current response generation. This component may ensure that historical content is accessible and usable, providing context and reference points for the GenAI engine 106. The historical content ingestion & consumption component 1038 may support the smart content component 1006 in delivering informed and contextually relevant responses.

Image and rich content recommendations component 1040 may enhance the visual appeal and informativeness of the RFP responses. This component may suggest relevant images, diagrams, and other rich content that may be incorporated into the responses to improve their quality and impact. This component may work with the smart writer component 1004 to ensure that visual elements are seamlessly integrated into the final document.

Other sources for content consumption 1042 may expand the range of data and information available for RFP response generation. This may integrate external data sources and repositories, providing the GenAI engine 106 with a broader base of content to draw from. This process may support the advanced semantic search component 1024 in retrieving high-quality and diverse information for response generation.

Focus points component 1044 may be used to highlight areas of attention and priority within the RFP process. The components designated as focus points are indicated by an asterisk (*) as shown in FIG. 10A. The focus points component 1044 may identify elements and tasks that require focus, ensuring that they are addressed effectively and efficiently. The focus points component 1044 may collaborate with the smart workflow component 1002 to ensure that all focus points are integrated into the overall process management strategy.

Day 2 deliverable component 1046 (also known as day-2 operations) refers to the ongoing enhancements and updates made to the RFP process after the initial implementation. This component may ensure that the system 100 remains current and effective, incorporating new features and improvements as needed. The Day 2 deliverable may work with the feedback loop component 1036 to identify and implement changes that enhance the overall quality and efficiency of the RFP process.

The Day 2 deliverables 1046 are the tasks that may operate as enhancements to keep the system 100 running after it has been deployed. In various embodiments, the Day 2 deliverables 1046 may include the following tasks: (1) understanding the lineage of the questions and drafting a cohesive story to make sure the system 100 does not repeat information but actually paints a full picture; (2) scoring RFP's for winnability and identifying weaker sections and stronger sections; (3) performing prioritization and escalation; and (4) having the ability to add pictures, charts, and graphs for the smart RFP.

The Day 2 deliverables 1046 may also include (5) drafting cover letters; (6) standardizing the biographies of people involved in the smart RFP; (7) including other features such as identifying weaknesses of the RFP and augmenting by finding content from the other agents using, for example, Agentic Architecture™ or other repositories which may have the content stored therein; and (8) providing additional capability to add and learn from historical RFP's and identify the human touch or the human nuance.

FIG. 10B illustrates alternative workflows within an AI smart integrated process 1000B of a smart workflow component 1050, a smart writer component 1052, and a smart content component 1054. In the alternative workflows, an RFP may have multiple sections, each corresponding to a different workflow. Each of the additional workflows may have multiple writers dealing with specific sections of the RFP.

The alternative workflows are adding humans and AI agents in the RFP response collaborative space. In the embodiments, an AI agent refers to a software entity that autonomously performs tasks or makes decisions based on its environment. AI agents may perceive their surroundings, process information, and take actions to achieve specific goals. Within the context of FIG. 10B, humans, and AI agents may collaborate.

That is, some matters may be answered by the AI agent and other matters may be performed by the human. However, as a final step, a human reviews, edits, and signs off on a final version of the RFP response. This approach may result in a completely integrated ecosystem which is an important underpinning of the embodiments.

An Agentic Architecture™ may provide a framework for how to build custom AI agents that may provide additional information that is not stored in the content repository but may be fetched from external sources. In some embodiments, an additional feature may be referred to as collaborative filtering which may include marking content, identifying content, etc.

The embodiments also provide an ability to score the RFP response being prepared. The present disclosure may provide one or more modules capable of scoring RFP's for winnability and identifying weaker sections and stronger sections of the response to the RFP. These modules may be configured to perform both statistical rule-based assessment and also GenAI-based assessment using historical data of RFPs that the client previously won versus lost. The scoring may also be based on comments and human feedback of reviewers, the strength of the answers provided, and all the blind spots that were not addressed that may show the organizational value and capability.

In embodiments, the system 100 may perform scoring based on blind spots, which may be employed as a method of evaluating the RFP response drafting performance or decision-making ability by specifically identifying and assessing the areas where the system 100 lacks awareness or understanding, essentially highlighting the “blind spots” which may lead to missed opportunities or poor judgments. Scoring based on blind spots may involve gathering feedback from others to reveal these unseen weaknesses and then assigning a score based on the severity or frequency of these blind spots.

In an embodiment, the system 100 may include a blind spot detection module (not shown) that is configured to detect a blind spot in the system by calculating a blind spot score. The blind spot detection module may perform an evaluation based on the blind spot score, to determine the drafting performance or decision-making capabilities of the SmartRFP software tool. Then, the blind spot detection module may identify, based on the evaluation, features of the system that indicate a lack of understanding of the RFP document.

In the various embodiments, scoring may help quantify the likelihood of winning a particular RFP, based on the content provided in the response in comparison to previous RFPs. The SmartRFP tool 166 may propose new content to increase the winnability score.

In the alternative workflows in FIG. 10B, the smart workflow component 1050 may coordinate the flow of information and tasks within the RFP process. This component may ensure a seamless transition from document input to final response generation. The smart workflow component 1050 may interact with other components, such as the smart writer component 1052 and the smart content component 1054, to manage the RFP lifecycle efficiently. The smart workflow component 1050 may facilitate the integration of various stages, enabling effective management and execution of the RFP process.

The smart writer component 1052 may generate the initial draft of the RFP response. This component may utilize advanced AI algorithms to produce coherent and contextually relevant answers to the identified questions. The smart writer component 1052 may collaborate with the smart content component 1054 to ensure that all responses align with the extracted questions and context. The smart writer component 1052 may play a role in ensuring that the GenAI engine 106 understands the document's structure and content.

The smart content component 1054 may ensure the quality and consistency of the generated RFP responses. This component may employ systematic content quality benchmarks to evaluate and refine the responses, ensuring that they meet predefined standards. The smart content component 1054 may collaborate with the smart writer component 1052 to continuously improve the content repository and enhance the overall quality of the RFP outputs.

A custom workflows component 1056 may allow for the creation of tailored processes to build parts of the RFP document across multiple users. This component may support multi-writer collaboration, enabling different stakeholders to contribute to the RFP simultaneously. The custom workflows component 1056 may integrate with the smart workflow component 1050 to ensure that all user inputs are coordinated and managed effectively.

An ability to collaborate, plan, and agent document component 1058 may facilitate collaboration between a human user and an AI agent. This component may allow for the integration of human and agent inputs, ensuring that the RFP process benefits from both automated and manual insights. The ability to collaborate, plan, and agent document component 1058 may support the smart workflow component 1050 by enabling seamless collaboration and planning.

An ability to review and override the content by both human and agent component 1060 may provide a mechanism for reviewing and modifying the generated RFP content. This component may ensure that both human users and AI agents can make necessary adjustments to the responses, maintaining the accuracy and relevance of the final output. The ability to review and override the content by both human and agent component 1060 may work with the smart content component 1054 to ensure that all modifications are tracked and implemented effectively.

A prioritizing high-value RFPs and important client RFP component 1062 may focus on identifying and prioritizing RFPs that hold significant value or importance. This component may ensure that resources are allocated efficiently to high-priority RFPs, enhancing the likelihood of successful outcomes. The prioritizing high-value RFPs and important client RFP component 1062 may collaborate with the smart workflow component 1050 to manage the prioritization process.

An ability to recommend historical RFPs with similar content and recommend winning content component 1064 may leverage past RFP data to inform current response generation. This component may identify historical RFPs with similar content and recommend winning strategies, enhancing the quality and effectiveness of the responses. The ability to recommend historical RFPs with similar content and recommend winning content component 1064 may integrate with the smart content component 1054 to provide contextually relevant recommendations.

A dashboards of RFPs component 1066 may provide a visual representation of the RFP process, offering insights into metrics such as winning RFPs and losing RFPs. This component may support data-driven decision-making by providing stakeholders with real-time information on RFP performance. The dashboards of RFPs component 1066 may integrate with management reporting to deliver comprehensive analytical insights.

A metrics on winning RFPs and losing RFPs component 1068 and a metrics on winning content and losing content component 1070 may evaluate the effectiveness of the RFP responses by analyzing the content's performance. These components may identify strengths and weaknesses in the content, providing insights for continuous improvement. These components may collaborate with the smart content component 1054 to refine the content repository based on performance metrics.

An RFPs in the pipeline and overall growth in assets under management (AUM) component 1072 may track the progress of RFPs within the pipeline and assess their impact on the organization's AUM. This component may provide stakeholders with a comprehensive view of the RFP process, supporting strategic planning and resource allocation. This component may integrate with the smart workflow component 1050 to manage the pipeline effectively.

In an embodiment, the pipeline may include the SmartRFP tool 166 and may be executable by one or more processors to implement a refinement process. To generate the RFP response document 164, the refinement process may be implemented continuously to refine various stages of the RFP process, for example, the layout extraction, layout parsing, context and question classification, and the generation of the answers. The refinement process may also include analyzing historical RFPs data and tracking previous RFP performance based on various types of metrics to provide insight to refine the various stages of processing the RFP.

An Agentic Architecture™ component 1074 may employ AI agents to search, recommend, and personalize RFP content from different data sources within the organization. This component may provide high-fidelity mechanisms (e.g., guardrails) to prevent hallucinations in the content provided. The Agentic Architecture™ component 1074 may collaborate with the smart content component 1054 to deliver accurate and personalized responses.

By way of example, using the Agentic Architecture™ component 1074, hallucinations may be avoided by matching topics under consideration with the existing content to reduce the amount of data being processed. Additionally, different types of questions may be generated from the same question to fine-tune the best approach to match the answers. Also, to the extent possible, highly used answers may be selected and added to the pipeline, along with citations for the answer.

That is, every answer that is produced may be accompanied by a citation to support the origin of the answer. Further, the answers provided herein may be the result of a curated ingestion of content, as opposed to being wholly created from scratch. This combination of steps, along with others, may help to prevent hallucinations.

Through the use of the Agentic Architecture™ component 1074 additional guardrails may be implemented by providing specific prompts/instructions to corresponding LLMs to ensure accurate RFP responses. Prompt language/expression may be carefully designed to guide the LLM's understanding and reduce ambiguity. The tone of the language/expression may be clearly defined and refined to suit the needs of the business.

In embodiments, close human oversight may also be provided. For example, answers may be closely reviewed by multiple parties for correctness and completeness before being finalized and entered into the final RFP response. Also, a feedback loop prompt may be provided after each interaction, allowing users to provide input on the tool's performance. As one example, the tool may utilize options, such as a “thumbs up/down” button to gather quick feedback.

In cases where the tool's performance remains suboptimal after mitigation efforts (e.g., fails to provide a satisfactory answer to the user), additional actions may be implemented. For example, content restructuring and creating a more vetted repository, or the ability to surface frequently used answers, may be provided to reduce toil.

The winning content from previous RFPs and a previous similar client component 1076 may focus on recognizing successful content from past RFPs and similar clients. This component may recommend content that has proven effective, enhancing the likelihood of winning future RFPs. This component may integrate with the smart content component 1054 to provide informed recommendations.

Scoring the RFP for winnability based on previous RFPs, client, and RFP content component 1078 may evaluate the potential success of an RFP by analyzing historical data and current content. This component may provide a winnability score, offering insights into areas for improvement. This component may collaborate with the smart workflow component 1050 to prioritize RFPs based on their winnability.

A prioritization inside the pipeline for high AUM and processing of the RFPs based on the priority component 1080 may ensure that RFPs with high AUM are prioritized within the pipeline. This component may allocate resources effectively, enhancing the efficiency and effectiveness of the RFP process. This component may integrate with the smart workflow component 1050 to manage prioritization and resource allocation. By way of example, low-value RFPs may be automated and relegated to review by an AI agent instead of a human, conserving and prioritizing human resources.

An Agentic® review process for low AUM RFPs and recommendations component 1082 may employ AI agents to review and recommend content for RFPs with lower AUM. This component may automate the review process, reducing manual effort and ensuring consistency in content recommendations. The component may collaborate with the smart content component 1054 to deliver high-quality responses.

Plug and play content from different data sources component 1084 may allow for the integration of content from various data sources, enhancing the diversity and richness of the RFP responses. This component may support the smart content component 1054 by providing a broader base of information for response generation.

A rich content extraction and creation component 1086 may focus on extracting and creating visually appealing and informative content for the RFP responses. This component may enhance the quality and impact of the responses by incorporating relevant images, diagrams, and other rich content. This component may collaborate with the smart writer component 1052 to ensure seamless integration of visual elements.

A crawler and weighing component 1088 may be used to compare, evaluate, and score new content in view of existing content. The new content may be compared with the existing data to determine the content's relevance and quality. These components may support the smart content component 1054 by ensuring that only high-quality content is used in the RFP responses.

A tables and graphs component 1090 may be provided that has the functionality to dynamically create tables and graphs (i.e., on the fly), based on the content available to improve the RFP quality. The functionality of this component may enhance the informativeness and clarity of the RFP responses. This component may collaborate with the smart writer component 1074 to ensure that visual data is presented effectively.

A recommendation for pictures and graphics component 1092 may recommend pictures and graphics where needed to make the RFP a more user-friendly document. By way of example, this component may suggest appropriate images and graphics to improve the user-friendliness of the RFP responses. This component may enhance the visual appeal and engagement of the responses, supporting the smart writer in delivering high-quality outputs.

An assessing the losing content component 1094 may be configured to identify the weaknesses of the content. This component may analyze the content that has not performed well in past RFPs or was not favorably received and identify areas for improvement. This component may provide insights into content weaknesses, supporting the smart content component 1054 in refining the content repository.

A tone and writing style scoring component 1096 may evaluate the tone and writing style of the RFP responses, ensuring they align with client expectations and preferences. This component may collaborate with the smart writer component 1052 to deliver responses that are not only accurate but also stylistically appropriate.

In comparison to a conventional RFP response process, the conventional RFP response process has been revamped and re-engineered using the SmartRFP tool 166, including the GenAI engine 106. The system and method of the present disclosure provide a transformative process that improves performance by upgrading and redesigning workflows, especially content workflows and content management. Content management is an important aspect of the quality of the RFP responses generated. The content management and content workflow may play a critical role in generating effective RFP responses in a timely manner. The quality of the content may directly impact the output of the RFP response tool.

A well-structured content workflow ensures good quality, consistency, and compliance, reduces rework, and improves acceleration. The content workflow may include tasks such as content creation, reviewing, editing, and approval. It may also include a content refresh process when content expires and needs to be revisited to add the latest information.

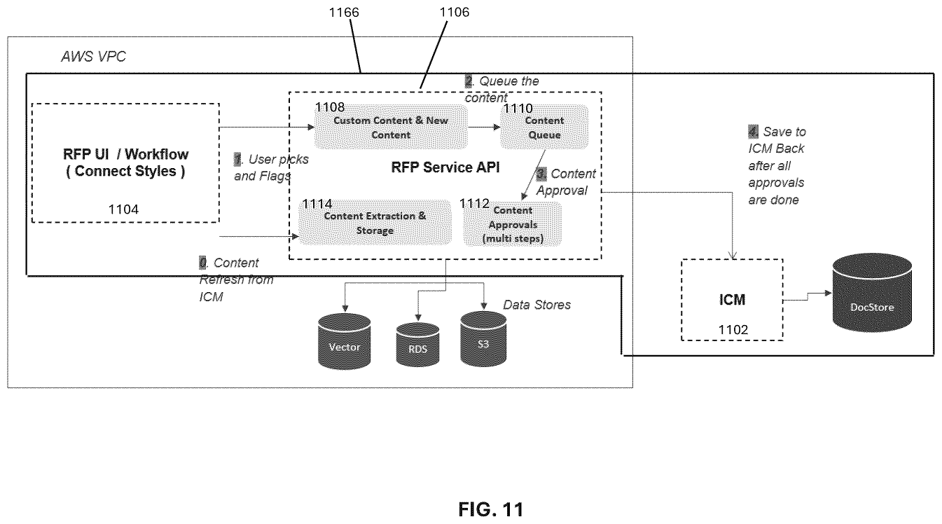

In addition to the teachings in FIG. 1, FIGS. 11-13 provide an enhanced content management and content workflow according to embodiments of the present disclosure. The content workflow provides a systematic process through which content may be created, reviewed, approved, and stored before being published or distributed. The goal may be to streamline the process and ensure that the content meets quality standards and is delivered in a timely manner. The content management may provide a process for storing and retrieving content.

In some embodiments, the content workflow may involve content approval. The content approval process may allow writers to submit content for review. During the content approval process, approvers or SMEs may evaluate the content quality and adherence to compliance. In the content approval process, feedback and edits may be provided by the user and entered into the system 100, and the workflow may track edits and changes made to the content. After approval, the approved content may be published and used by downstream systems.

In various embodiments, the content workflow may include content refresh. In such a case, scheduling and alerting of the content refresh process may be set at predefined intervals. During the content workflow, the approval process may be configured to require designated approvers to review and authorize the content refresh before it can be executed. Tracking and management of the approval process may include sending notifications to approvers and maintaining an audit trail.

In an embodiment, a core capability of the system 100 may support the content workflow being deployed in a content cloud environment. In some embodiments, a custom workflow for specific document types may be built in the system 100. In an embodiment that implements the custom workflow, prioritization and resource allocation may need to be established when implemented inside an ICM for a specific document type.

In the embodiments of FIGS. 1 and 11-13, to ensure that the data remains current and accurate, the system 100 may employ a content queue mechanism. This mechanism may allow writers to flag answers that may be either reused or updated. These flagged answers may then enter into a streamlined workflow process, where they may be evaluated and approved by various roles to maintain a Golden Source of content. As a result, system 100 may prevent outdated content from being reused and ensures that content is constantly updated and refreshed in response to new questions and answers.

In an exemplary workflow of a content queue process, the process may include the steps of flagging reusable content, content manager approval, SME approval, and supervisory manager (SM) approval.

Through the use of a UI, an RFP writer may flag an answer that the writer believes should be reused (i.e., new content) or updated (i.e., existing content). The flagged answer may be either new content that provides a fresh perspective or existing content that has been updated to reflect current standards. The flagged answer may be sent to a content manager. The content manager using a UI may review the content for quality, relevance, and alignment with the organization's standards. If the content meets all criteria, it may be approved and forwarded to the SME. If the content does not meet the criteria, it may be sent back to the originator for refinement.

During the SME approval, the SME may receive the approved content from the content manager. Using the UI, the SME may review the content for technical accuracy, ensuring that it is correct and applicable. The SME may approve the content that meets technical standards and send it to the SM. Content that does not meet technical standards may be abandoned by the SME.

During the SM approval, the SM receives the content approved by the SME. The SM may interact with a UI to conduct a final review to ensure that the content aligns with strategic goals and overall quality. Approved content may be added to the organization's Golden Source, ensuring that it may be reused and remains up to date. Disapproved content may be abandoned or returned to the SME for further adjustments.

Within the context of content management, the system 100 may be designed to provide several functionalities that may be used by an RFP team. For example, centralized content store for securing storage and management of digital assets may be provided. As another example, advanced search functionality with filters like keywords, tags, and file types may be provided. Namely, the system 100 may be capable of handling metadata attributes and may possess metadata management capabilities for adding, editing, and organizing content information. Enhanced content discoverability for improved productivity and workflow efficiency may be provided in various embodiments.

To give a further example of the functionalities within the context of content management, customizable taxonomies, and categories for creating a logical and user-friendly content hierarchy may be included in the system 100. In particular embodiments, version control and revision history may enable tracking and management of different iterations of the content and the metadata. In a further example, seamless integration with other systems and platforms may be performed through APIs. In an embodiment, user access control and permission management may be provided for data security and privacy.

In various embodiments, the content store may include several features. For example, the content store may include a centralized content store for secure storage and management of digital assets. As another example, keyword-based search functionality with filters like keywords, tags, file types, and metadata attributes may be included. In particular embodiments, metadata management capabilities may be provided for adding, editing, and organizing content information. Some embodiments may provide customizable taxonomies and categories for creating a logical and user-friendly content hierarchy.

As another example, version control and revision history may be included to track and manage different iterations, for example, of only metadata. Various embodiments may implement seamless integration with other systems and platforms through APIs. In particular, user access control and permission management for data security and privacy may be included within the content store.

FIG. 11 illustrates an alternative embodiment of the SmartRFP tool 1166, similar to the SmartRFP tool 166 depicted in FIG. 1. Some components in FIG. 11 are similar to those depicted in FIG. 1. Therefore, a description of those components will not be repeated here.

In FIG. 11, the starting point of the content workflow may begin with data collection or data ingestion, for example, of an RFP document from various sources received at an RFP UI/Workflow component 1104. The content, including the content of an RFP document 158, may be transferred to an RFP Service API 1106 for further processing. In an example, the RFP Service API 1106 may include a custom content and new content component 1108, a content queue component 1110, a content approvals component 1112, and a content extraction and storage 1114.

In this phase, the custom content and new content component 1108 may facilitate the creation of new content or customized content tailored to specific needs based on the uploaded RFP document 158.

In embodiments, the content queue component 1110 may receive the content from the custom content and new content component 1108. The content queue component 1110 may serve as a holding area where all new and upcoming content may be listed and organized for review and approval. After the content is created, it may be placed into the queue, using, for example, a project management or CMS. The queue may allow stakeholders to view the status of all content pieces, track progress, and prioritize tasks. The system 100 may ensure that no content is overlooked and that the team may work on multiple pieces simultaneously, following a predefined schedule for review and release.

After the content is placed in the queue, it may undergo a rigorous approval process performed by the content approvals component 1112. The content approvals component 1112 may enable the stakeholders (such as managers, editors, or legal teams) to review the content to ensure that it meets all criteria-accuracy, brand voice, compliance, and alignment with business goals. Feedback may be provided, and revisions may be requested. In some cases, the content may pass multiple rounds of review before final approval. The content approvals component 1112 may ensure that the content is polished, error-free, and consistent with the company's objectives before it moves forward.

In FIG. 11, the content extraction and storage component 1114 may extract the content from the content workflow and store it in a central content repository or storage system. This may be a cloud-based CMS, a file storage platform, or a digital asset management (DAM) system. The content may be organized in a way that makes it easy to retrieve and repurpose for future use. Proper storage may ensure that all approved content may be archived for potential reuse, legal compliance, and easy access by other departments or teams.

In the approach of FIG. 11, the content may remain stored in an ICM component 1102 as a master store. There may be a one-time update of the ICM data into the RFP response. Meanwhile, the users may continue to use the content in the RFP and flag reusable content to be queued. Any expired content and new content may be queued for processing. The content may be available for review/approval. Then, the content may be returned to the ICM component 1102 as the master RFP store that may be configured as a transient store, and SMEs may receive reminders for approvals.

As the master store, the ICM component 1102 may function as a central, authoritative data store or memory that holds crucial or primary information or master data, which other systems or components may refer to or interact with. The ICM component 1102 may serve as a source of truth or the primary repository for important data. This data may be central and synchronized across various systems within an organization. The ICM component 1102 being configured as the master store may ensure that there is a single, consistent version of important data, which may be then distributed and synchronized to other databases or applications as needed.

In various embodiments, in FIG. 11, the ICM component 1102 may be configured as an enterprise store that provides a centralized repository for business information. Although one of the common features of a typical enterprise store is file sharing, FIG. 11 illustrates that, in an embodiment, the content may not be moved from the enterprise store. Also, no new policies or visibility rules may need to be applied as the store may be accessible to existing clients.

In embodiments, the ICM component 1102 as the enterprise store may manage risks, controls, and compliance. In such a scenario, the ICM component 1102 may be configured as the database where all information related to potential risks, mitigation controls, and adherence to relevant compliance regulations are stored and managed centrally, allowing for a holistic view of the organization's risk profile and compliance status across all departments and operations.

In an exemplary embodiment in FIG. 11, metadata management may also be provided so that all data in a business glossary resides in the ICM component 1102. In such an embodiment, the users may continue with their ad-hoc queries. In embodiments, the ICM component 1102 may be a business glossary for providing a repository of terms and definitions specific to a company's products, processes, and industry. The business glossary may be used to ensure that everyone in the organization uses the same definitions when analyzing data.

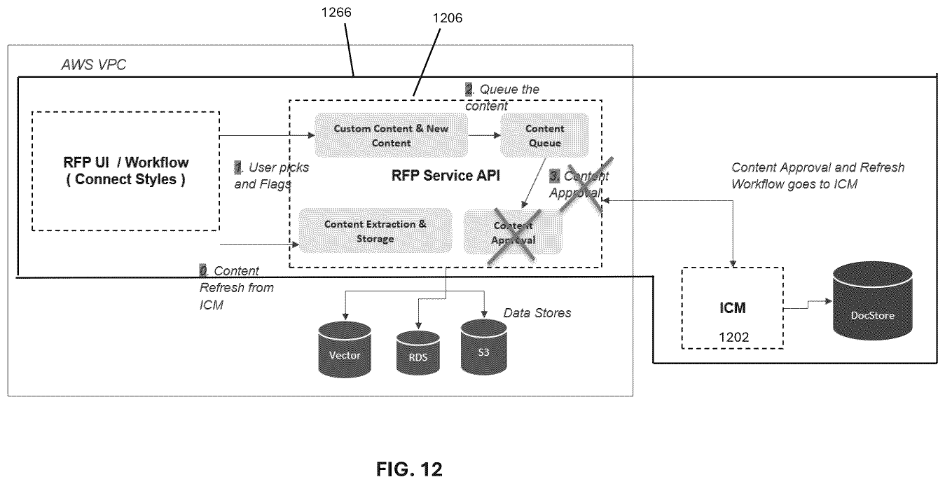

FIG. 12 depicts a further alternative embodiment of the SmartRFP tool 1266 with content workflow. Some components in FIG. 12 are similar to those depicted in FIGS. 1 and 11. Therefore, a description of those components will not be repeated here.

In FIG. 12, the content remains in an ICM component 1202, which may be configured as a content store. In embodiments, the content store may refer to a storage location that manages, stores, and organizes content, which may include a wide range of data types such as text, images, videos, audio files, documents, or other media assets. The content store may be designed to allow efficient access to, retrieval, and management of this content, in environments where content may be accessed, updated, or delivered across multiple systems or by multiple users. The content may be managed through an interface that allows users to create, edit, and publish.

In FIG. 12, the SmartRFP tool 1266 may be frequently refreshed per schedule into the RFP because the ICM component 1202 may receive new content after the workflow completes its process. Users may continue to use the content in the RFP and flag reusable content. Expired content and new content may be queued for processing inside the ICM component 1202 where the automated workflow may be built and automatically or manually triggered to initiate the workflow process. In such a case, the ICM component 1202 may function as a content workflow management system, and the SME may receive reminders for approvals.

In comparison to FIG. 11, in various embodiments of FIG. 12, the content approval may not be performed in the RFP Service API 1206. Rather, the content approval may be performed in the ICM component 1202.

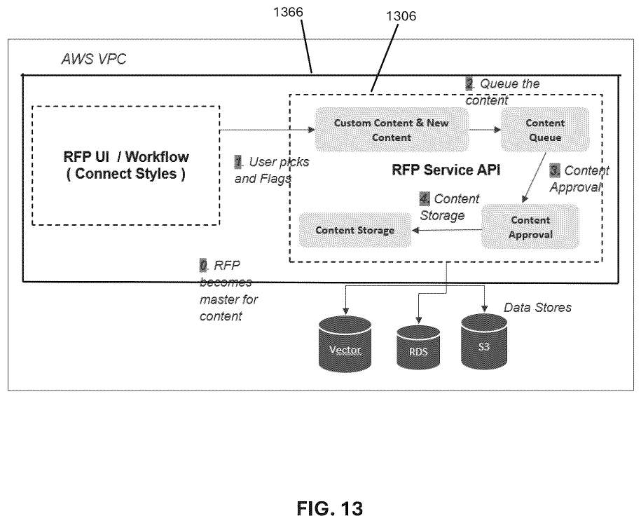

FIG. 13 depicts a further alternative embodiment of the SmartRFP tool 1366 with content workflow after the replacement of ICM controls. Some components in FIG. 13 are similar to those depicted in FIGS. 1 and 11-12. Therefore, a description of those components will not be repeated here.

In comparison to FIGS. 11 and 12, the embodiment in FIG. 13 does not include an ICM component. Content is moved to an RFP Service API 1306. Users may use the content and flag reusable content. Expired content and new content may be queued, and all reviews/approvals are processed inside the RFP Service API 1306. Content may be saved back to an RFP store and reused for other purposes. All controls may be implemented inside the RFP Service API 1306 and the SME's may receive reminders for approvals.

In this embodiment, the data may remain in one place. There are no synchronization or refreshes. New policies and visibility rules may need to be applied as the store may be accessible for existing clients. This approach may reduce the overall complexity of the system 100.

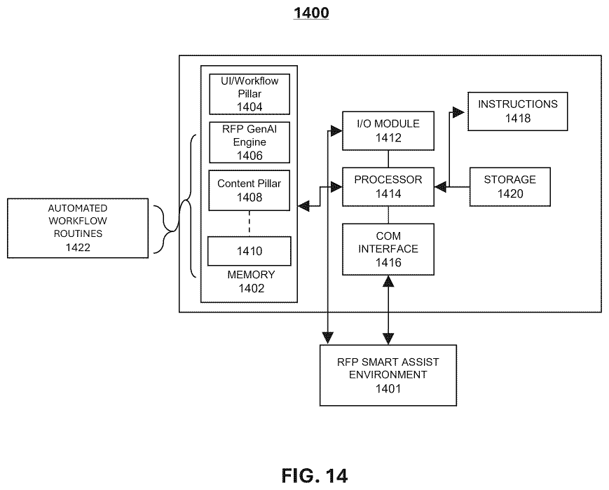

FIG. 14 describes an exemplary computing system 1400 configurable to execute the various methods and processes described above. In the computing system 1400, a method (e.g., the method 200) or steps thereof as described herein may be embodied as instructions that may cause the computing system 1400 to perform operations consistent with auto-syncing an application pod to a desired state using a feedback mechanism to monitor observability errors and dynamically fix, redeploy, or change a state of one or more pods in an application pod. For example, the method may be embodied as instructions residing in a non-transitory component such as a memory or a storage device associated with the computing system 1400. That is, the structure of the computing system 1400 may be imparted by the methods described herein in the form of instructions.

In embodiments, the computing system 1400 may be an application-specific hardware, software, and firmware implementation (or a combination thereof) configured to execute the exemplary methods described herein. The system 1400 may also represent a structural and application-specific implementation of the other exemplary systems described herein (e.g., the system 100). The computing system 1400 may include a processor 1414 configured to execute one or more, or all of the steps of the exemplary methods described previously.

The processor 1414 may have a specific structure imparted thereto by instructions 1418 stored in a memory 1402 and/or by instructions 1418 fetchable by the processor 1414 from a storage medium 1420. The storage medium 1420 may be co-located with the computing system 1400 as shown, or it may be remote and communicatively coupled to the computing system 1400. Such communications may be encrypted.

The computing system 1400 may be a stand-alone programmable system, or a programmable module included in a larger system. For example, the computing system 1400 may be included as part of a cloud environment or as a part of computing system 1400 configured to monitor and reconfigure a cloud environment. Also, the computing system 1400 may include one or more hardware and/or software components configured to fetch, decode, execute, store, analyze, distribute, evaluate, and/or categorize information.

The processor 1414 may include one or more processing devices or cores (not shown). In some embodiments, the processor 1414 may be a plurality of processors, each having one or more cores. The processor 1414 may execute instructions fetched from memory 1402, i.e., from one of memory modules 1404, 1406, 1408, or 1410. By way of example only, and not limitation, the memory module 1404 may store instructions that represent the UI/Workflow pillar 104, the memory module 1406 may store instructions that represent the RFP GenAI engine 106, and the memory module 1408 may store instructions that represent the content pillar 108.

Alternatively, the instructions may be fetched from the storage medium 1420 or from a remote device connected to the computing system 1400 via a communication interface 1416. An I/O module 1412 may be configured for additional communications to or from remote systems or to a user interface 1403 from which the processor 1414 may receive a set of requirements. Such additional communications may be facilitated by a communications interface 1416.

Without loss of generality, the storage medium 1420 and/or the memory 1402 may include a volatile or non-volatile, magnetic, semiconductor, tape, optical, removable, non-removable, read-only, random-access, or any type of non-transitory computer-readable computer medium. The storage medium 1420 and/or the memory 1402 may include programs and/or other information usable by processor 1414, such as, for example, instructions that enable the processor 1414 to perform AI-assisted automated RFP response generation in a VPC environment. Furthermore, the storage medium 1420 may be configured to log data processed, recorded, or collected during the operation of the system 1400.

The data may be time-stamped, location-stamped, cataloged, indexed, encrypted, and/or organized in a variety of ways consistent with data storage practice. By way of example, the memory modules 1404 to 1410 may form instructions that embody the method 200. In other words, the memory modules 1404 to 1410 may form a set of automated self-healing routines 1422 that may cause the processor 1414 to perform certain operations upon execution of an RFP smart assist environment 1401 that is communicatively coupled to the system 1400.

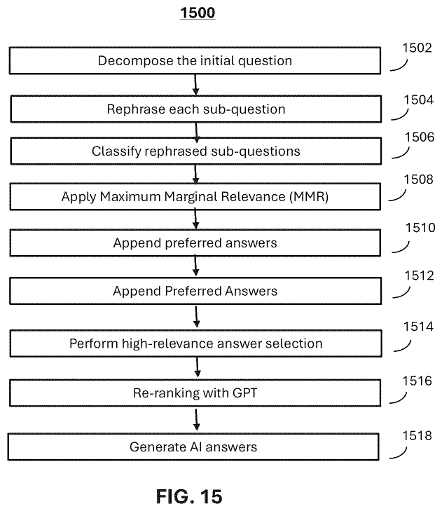

FIG. 15 illustrates a flow diagram of another exemplary method 1500 of performing AI answer generation process in response to a question in an RFP document, using the system of FIG. 1, in accordance with the embodiments. In an embodiment, method 1500 may employ the answer generation component 142 to implement the AI answer generation process in response to receiving the question included in the RFP document, in accordance with the embodiments.

At step 1502, an initial question may be decomposed into multiple SQs. The system may break down a complex question into multiple simple SQs.

At step 1504, each SQ may be rephrased in several ways. The system may rephrase each SQ into various ways, ensuring comprehensive coverage of the subject matter of the question.

At step 1506, each rephrased SQ may be classified into predefined topics. The system may classify each rephrased SQ into predefined topics using ML classification models.

At step 1508, the rephrased SQs may be converted into embeddings. The system may convert each rephrased SQ into embeddings (i.e., vector representation) for computational analysis.

At step 1510, MMR may be applied to compare the embeddings and to assess the relevancy of each answer. The system may utilize MMR thresholding to assess and compare the relevance of the embeddings from both the question and golden repository content to identify the most pertinent answers.

At step 1512, the preferred answers may be appended according to user feedback to ensure alignment with user-defined preferences and improve solution accuracy. Based on the feedback from the user, the system may append preferred answers to the list of all high relevant answers.

At step 1514, the most relevant answers may be selected based on MMR scores, ensuring high relevance. The system may select high-relevance answers based on their MMR scores, ensuring inclusion of highly recommended responses.

At step 1516, the selected answers may be re-ranked and refined using GPT. The system may use GPT to re-rank the selected answers, prioritizing the selected answers with the highest relevance score.

At step 1518, AI answers may be generated that integrate personalized context and content from an extraction step, as described above in the discussion of FIG. 3A. Also, at step 1518, the SQ answers may be merged to generate a comprehensive response for the main question. The system 100 may generate personalized AI answers by integrating the context summary from the extraction step and merge the answers of the SQs for a cohesive, comprehensive response.

In embodiments, the SmartRFP disclosure introduces a novel approach to automating the RFP process by integrating advanced AI and machine learning technologies. Unlike traditional manual methods, this system leverages a GenAI engine to extract content, identify questions, and generate precise answers using a designated Golden Source, ensuring accuracy and consistency. The disclosure's unique collaboration platform allows multiple stakeholders to work simultaneously, tailoring responses to specific client needs.

Additionally, the workflow management system seamlessly may integrate various RFP stages, automating tasks and enhancing efficiency. The inclusion of a feedback mechanism for continuous content improvement, along with guardrails to prevent hallucinations and ensure fairness, further distinguishes this disclosure. By transforming the RFP process into a streamlined, scalable, and adaptable system, the SmartRFP significantly reduces manual effort, minimizes errors, and aligns with modern business needs, offering a comprehensive solution for effective RFP management.

The examples may also be embodied as one or more non-transitory computer-readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

Although the present application describes specific embodiments that may be implemented as computer programs or code segments in computer-readable media, it is to be understood that dedicated hardware implementations, such as application-specific integrated circuits, programmable logic arrays, and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

In various embodiments, the SmartRFP tool 166, 1166, 1266, 1366 (which may be collectively referred to simply as SmartRFP tool 166) may provide various benefits to an organization. The SmartRFP tool 166 aims to automate the RFP process, enhance collaboration, standardize document format, and improve efficiency and controls (risk mitigation) within the OCIO business group. Its capabilities include automated document generation, version control, integration with external systems, and user access control. By achieving these objectives, SmartRFP 500B tool enables streamlined and effective RFP management.

Additional benefits may include increased efficiency by significantly reducing the time and effort required for manual RFP creation, review, and approval processes. The RFP response accuracy may be enhanced by automating the generation of RFP documents. In this manner, the SmartRFP tool 166 may help to minimize human errors, improving the overall accuracy of the process. Collaboration and communication may also be improved. The SmartRFP tool 166 may foster collaboration among stakeholders by providing a centralized platform for document sharing, discussions, and feedback. The SmartRFP tool 166 may also enable data-driven decision-making by allowing users to analyze data and generate reports and provide valuable insights for informed decision-making.

Specific examples of the benefits of the RFP assist Tool 166 to clients, advisors, and the organization may include modernization of the RFP response process which may scale OCIO AUM growth of at least 3× from new wins by the organization over a five-year period. In another example, an OCIO RFP team may help team members across the organization to respond to RFPs, especially high-dollar and high-value RFPs. A further example may include automated RFP response processes that are popular and are credited with helping to improve RFP advancement rates.

The SmartRFP tool 166 may address service level agreement (SLA) and latency requirements. For example, response time may be improved. RFP doc for extraction and classification times may be reduced to around 5 mins and generation may be around 20 mins. The SmartRFP tool 166 may maintain a minimum uptime may be as high as 99% to ensure availability and reliability for its users during the RFP response process. The SmartRFP tool 166 may provide timely support to users, with a target of resolving critical issues within 48 hours and non-critical issues within 72 hours.

With respect to evaluation and methodology, AI-generated content evaluation tools may be used. An example of one such tool is “TRUE,” which is a lending platform that uses algorithms, blockchain, or digital verification, although other tools may be within the spirit and scope of the embodiments. In the embodiments, RFP content generation may be compared against historical RFPs for content retrieval and personalization. Periodic evaluations of the SmartRFP tool 166 may be performed. For example, at least biweekly, periodic evaluations may be performed to track user feedback, identify areas for enhancement, and ensure alignment with user needs and expectations.

In various embodiments, the purpose of the ICM may be to shape the firm's client-facing documentation strategy and to create the foundation for client documentation governance. Additional roles of the ICM may be to reduce the risks, standardize processes, and improve the user experience for the business users across wealth management and for a legal team to conduct reviews.

As a near-term solution, the content workflow may be built in an RFP application and may queue all the content (new and expired). A tentative approval workflow may be built to keep the ICM synchronized. The users may continue to query the ICM for ad-hoc queries. Project timelines may be slightly altered, all controls may be intact, and users may still search for data from ICM. A strategic solution may include building the content workflow in the ICM and only building delta features (i.e., audit tracking content) that are not available in ICM.

A pattern may be developed that all document types may follow and the ICM may be leveraged to its potential. Controls may be intact. Another strategic solution may include building the content workflow in the RFP response and removing the ICM completely. In such an embodiment, there may be less complexity in the system because the entire process may occur in one place along with semantic search.

In the embodiments of the present disclosure, domain-specific agents APIs may be used to provide content management. Embodiments of the present disclosure may provide multisource content availability. With the advent of LLM-based products, domain-specific agents/APIs may be built to surface the best content that may be leveraged inside the RFP response generation tool.

The table below illustrates a list of exemplary agents available to be leveraged by various components within system 100. This table is non-exhaustive and here for exemplary purposes.

| Agents | Functionality |
|---|---|
| Factset | Receive live and up-to-date market data directly from FactSet |
| Portfolio | Help find which clients are holding security, have large exposure to a specific sector, or |
| Search | have upcoming maturity events |
| Investment | Drawing on internal, external and web content written by the J.P. Morgan Global |
| Content | Investment Strategy Team, it can answer questions about our views on the market, the |
| | economy and other global affairs. |
| CRM | Quickly summarize client engagement opportunities at a book level |
| BondGPT | |
| Davinci | finding external people based on their net worth, education, location, interests, passions |
| | and pursuits |
| Lending | |
| Planning | Planning content to answer questions and summarize documents drawing on internal, |
| Content | external and web content written by J.P. Morgan Global Investment Strategy Team. |
| Alternative | Helps advisors to query alts in real time and Make it easier to sell/support alternatives, |
| Investments | and reduces |
| Doc Manager | Content and Document Management's flavor of the OpenAI offering ChatGPT |
| ChatCFO | |

In accordance with embodiments, various components may be incorporated into the SmartRFP tool 166. In an embodiment, examples of three key components may include technology, user support, and content management.

In an embodiment, the technology component may provide maintenance and improvement of LLMs, enhancements to the UI and user experience (UX), database maintenance and improvement, and an integration roadmap, such as Paragon's Connect Portal, for enabling integrations for user interactions and obtaining more data from the users to complete the RFP's.

In an embodiment, the user support component may provide access management to ensure secure and appropriate user access. It may also provide training programs for users, and an RFP hub/specialist support model for advisors, providing guidance on where to go for specific needs.

In an embodiment, the content management component may provide structured content taxonomy for organized content management and defined Golden Source and refresh processes to maintain content accuracy and relevance. The embodiments may also leverage a content coach, market facts, and technology for efficient information sourcing and updates.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments that fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A system for automating a request for proposal (RFP) process, comprising:
a communication interface configured for receiving an RFP document as input;
a SmartRFP software tool configured for processing the RFP document to generate an RFP response document, wherein the SmartRFP software tool comprises:
a user interface communicatively coupled to the communication interface to receive the RFP document and manage an RFP process;
a generative artificial intelligence (GenAI) engine configured to extract content from the RFP document, identify questions in the RFP document, and generate contextually accurate answers based on the client persona and identified questions using an authoritative repository;
wherein the GenAI generates the answers by decomposing the identified questions into multiple sub-questions, rephrasing each sub-question, and classifying each rephrased sub-question into one or more topics; and
a content management system for managing and building the content and for storing and retrieving the content from the authoritative repository in collaboration with the GenAI engine; and
an application programming interface (API) component configured to facilitate data exchange and integration with other applications and to support interoperability and extensibility of the SmartRFP software tAool;
a persistent component communicatively configured to store the data in one or more persistent databases;
an open AI component configured to integrate AI capabilities with the SmartRFP software tool to enhance processing and analysis of the RFP document; and
a downstream review component configured to review, finalize, and approve the RFP response document downstream in the RFP process;
a dashboard calculating and reporting performance and data insights.

2. The system of claim 1, wherein the SmartRFP software tool is configured to utilize embeddings techniques and machine learning models for processing the RFP document.

3. The system of claim 2, wherein the GenAI is configured to implement parallel processing of PDF files to read all pages of a PDF document simultaneously using parallel processing algorithms for content extraction.

4. The system of claim 1, wherein the content management system is configured to:
self-learn or self-tag to identify winning content;
calculate a winnability score to quantify a likelihood of winning a particular RFP; and
for continuously updating the authoritative repository with content having a high winnability score for reuse for processing future RFPs.

5. The system of claim 1, further comprising a pipeline executable by one or more processors to implement a refinement process;
wherein the pipeline includes the SmartRFP software tool;
wherein the refinement process is implemented continuously to refine various stages of the RFP process; and
wherein the refinement process includes analyzing historical RFPs data and tracking previous RFP performance based on various types of metrics to provide insight to refine the various stages of the RFP process.

6. The system of claim 1, further comprising a content queue mechanism configured to flag the answers for reuse or update and subject flagged answers to a streamlined workflow process for evaluation and approval.

7. The system of claim 1, wherein the SmartRFP software tool is configured to generate the RFP response document in various formats while maintaining an original layout of the RFP document.

8. The system of claim 1, wherein the one or more persistent databases include at least one of a vector database, a relational database, and a cloud storage service to manage the storage and retrieval of the data.

9. The system of claim 1, wherein the GenAI engine is configured to generate personalized answers based on the context of the identified questions.

10. The system of claim 1, further comprising a feedback mechanism coupled to a workflow management system for continuous content enhancement and quality improvement.

11. The system of claim 1, further comprising a hallucination prevention module for preventing hallucinations and ensuring fairness in the RFP response document by providing references to authoritative sources used.

12. The system of claim 1, further comprising a collaboration platform for enabling simultaneous stakeholder input and tailored responses and for supporting simultaneous editing and commenting on the RFP documents by multiple users.

13. The system of claim 1, further comprising a blind spot detection module configured to:
detect a blind spot in the system by calculating a blind spot score;
perform an evaluation, based on the blind spot score, to determine a drafting performance or decision-making capabilities of the system; and
identify, based on the evaluation, features of the system that indicate a lack of understanding or awareness of the RFP document.

14. A method for automating a request for proposal (RFP) process, comprising:
receiving an RFP document as input at a communication interface;
processing the RFP document, using a SmartRFP software tool, to generate an RFP response document;
communicatively coupling a user interface to the communication interface to receive the RFP document and manage an RFP process;
processing the RFP document, using a generative artificial intelligence (GenAI) engine to extract content from the RFP document, identify questions in the RFP document, and generate answers based on the identified questions using an authoritative repository;
generating the answers by decomposing the identified questions into multiple sub-questions, rephrasing each sub-question, and classifying each rephrased sub-question into one or more topics;
managing and building the content, using a content management system;
storing and retrieving, using the content management system, the content from the authoritative repository in collaboration with the GenAI engine;
facilitating data exchange and integration with other applications and supporting interoperability and extensibility of the SmartRFP software tool using an application programming interface (API) component;
storing the data in one or more persistent databases;
integrating the AI capabilities with the SmartRFP software tool to enhance processing and analysis of the RFP document using open AI services; and
reviewing, finalizing, and approving the RFP response document downstream in the RFP process.

15. The method of claim 14, further comprising utilizing embeddings techniques and machine learning models for processing the RFP document.

16. The method of claim 15, further comprising implementing parallel processing of PDF files to read all pages of a PDF document simultaneously using parallel processing algorithms for content extraction.

17. The method of claim 14, further comprising self-learning or self-tagging to identify winning content and calculate a winnability score to quantify a likelihood of winning a particular RFP and for continuously updating the authoritative repository with content having a high winnability score for reuse for future RFPs.

18. The method of claim 14, further comprising utilizing one or more processors to execute a pipeline to implement a refinement process;
wherein the pipeline includes the SmartRFP software tool;
wherein the refinement process is implemented continuously to refine various stages of the RFP process; and
wherein the refinement process includes analyzing historical RFPs data and tracking previous RFP performance based on various types of metrics to provide insight to refine the various stages of the RFP process.

19. The method of claim 14, further comprising:
detecting a blind spot, in an automated RFP processing system including the SmartRFP software tool, by calculating a blind spot score;
performing an evaluation, based on the blind spot score, to determine a drafting performance or decision-making capabilities of the automated RFP processing system; and
identify, based on the evaluation, features of the SmartRFP software tool that indicate a lack of understanding or awareness of the RFP document.

20. A method for automating answer generation in a request for proposal (RFP) process, comprising:
receiving an RFP document as input at a generative artificial intelligence (GenAI) module;
identifying questions in the RFP document;
decomposing the identified questions into sub-questions;
rephrasing the sub-questions;
classifying each rephrased sub-questions into one or more predefined topics;
expanding each rephrased sub-question into multiple queries to cover different aspects of the sub-questions;
embedding each query to create vector representation for performing similarity searches to calculate a similarity score;
retrieving relevant documents for each query based on the similarity score;
re-ranking, using a generative pre-trained transformer, the relevant documents to identify most relevant documents based on the similarity score;
processing the most relevant documents to generate AI answers for each sub-question; and
compiling and merging the generated AI answers to generate a comprehensive response for each sub-question.
